(19) United States
(12) Patent Application Publication
(10) Pub. No.: US 2024/0223327 A1
(43) Pub. Date: Jul. 4, 2024

(54) COMMUNICATION APPARATUS IN WIRELESS COMMUNICATION SYSTEM AND METHOD PERFORMED BY THE SAME

(71) Applicant: Samsung Electronics Co., Ltd., Suwon-si (KR)

(72) Inventors: Di SU, Beijing (CN); Chen QIAN, Beijing (CN); Peng LIN, Beijing (CN)

(21) Appl. No.: 18/398,914

(22) Filed: Dec. 28, 2023

(30) Foreign Application Priority Data
Dec. 30, 2022 (CN) 202211728388.8

(51) Int. Cl. H04L 5/00; H04B 1/713; H04L 1/00; H04W 72/1273

(52) U.S. Cl. CPC H04L 5/0048; H04B 1/713; H04L 1/0013; H04W 72/1273

(57) ABSTRACT

A method performed by a communication apparatus in a wireless communication system is provided. The method includes determining configuration information on at least one physical signal cluster, and transmitting the at least one physical signal cluster based on the configuration information on the at least one physical signal cluster, wherein the physical signal cluster includes at least one physical signal block, wherein the physical signal block includes N repetitions of a sequence, and wherein the N is an integer greater than or equal to 1.

### CROSS-REFERENCE TO RELATED APPLICATION(S)

This application is based on and claims priority under 35 U.S.C. § 119(a) of a Chinese patent application number 202211728388.8, filed on Dec. 30, 2022, in the Chinese Intellectual Property Office, the disclosure of which is incorporated by reference herein in its entirety.

### BACKGROUND

### 1. Field

The disclosure relates to the technical field of wireless communication. More particularly, the disclosure relates to a communication apparatus in a wireless communication system and a method performed by the same.

### 2. Description of Related Art

Fifth generation (5G) mobile communication technologies define broad frequency bands such that high transmission rates and new services are possible, and may be implemented not only in “Sub 6 GHz” bands such as 3.5 GHZ, but also in “Above 6 GHz” bands referred to as millimeter wave (mmWave) including 28 GHz and 39 GHz. Additionally, it has been considered to implement sixth generation (6G) mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

There are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) user equipment (UE) Power Saving, Non-Terrestrial Network (NTN) which is UE-satellite direct communication for providing coverage in an area in which communication with terrestrial networks is unavailable, and positioning.

There has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. New research is scheduled in connection with extended Reality (XR) for efficiently supporting Augmented Reality (AR), VR Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a communication apparatus in a wireless communication system and a method performed by the same.

Additional aspects will be set forth in part in the description which follows and, in part, will be apparent from the description, or may be learned by practice of the presented embodiments.

In accordance with an aspect of the disclosure, a method performed by a communication apparatus in a wireless communication system is provided. The method includes determining configuration information on at least one physical signal cluster, and transmitting the at least one physical signal cluster based on the configuration information on the at least one physical signal cluster, wherein the physical signal cluster includes at least one physical signal block, and the physical signal block includes N repetitions of a sequence, where N is an integer greater than or equal to 1.

In some aspects, for example, the configuration information on the at least one physical signal cluster includes one or more of information indicating that the at least one physical signal cluster is aperiodic, information on a duration of the at least one physical signal cluster, information on a number of the at least one physical signal cluster, information on a time interval between adjacent physical signal clusters of the at least one physical signal cluster, information on a number of the physical signal blocks in the physical signal cluster, information on a number of the repetitions of the sequence included in the physical signal block, information on a beam used for the at least one physical signal cluster, a start time offset of transmission of the at least one physical signal cluster, a subcarrier spacing of the physical signal block in the physical signal cluster, a frequency-domain mapping of the at least one physical signal cluster, a frequency hopping pattern of the at least one physical signal cluster, a frequency hopping bandwidth of the at least one physical signal cluster, a number of frequency hopping subbands within the frequency hopping bandwidth of the at least one physical signal cluster, or a bandwidth of each frequency hopping subband within the frequency hopping bandwidth of the at least one physical signal cluster.

In some aspects, for example, the configuration information on the at least one physical signal cluster includes one or more of information indicating that the at least one physical signal cluster is periodic, information on a duration of the at least one physical signal cluster in a period, information on a number of the at least one physical signal cluster in the period, information on a time interval between adjacent physical signal clusters of the at least one physical signal cluster, information on a number of the physical signal blocks in the physical signal cluster, information on a number of the repetitions of the sequence included in the physical signal block, information on a beam used for the at least one physical signal cluster, a start time offset of transmission of the at least one physical signal cluster, a subcarrier spacing of the physical signal block in the physical signal cluster, a frequency-domain mapping of the at least one physical signal cluster, a frequency hopping pattern of the at least one physical signal cluster, a frequency hopping bandwidth of the at least one physical signal cluster, a number of frequency hopping subbands within the frequency hopping bandwidth of the at least one physical signal cluster, or a bandwidth of each frequency hopping subband within the frequency hopping bandwidth of the at least one physical signal cluster.

In some aspects, for example, the subcarrier spacing of the physical signal block is configured such that a length of a time-domain symbol occupied by the physical signal block is greater than that of other time-domain symbols of a time unit including the time-domain symbol.

In some aspects, for example, bands of the physical signal blocks are allocated based on the frequency hopping pattern. The frequency hopping pattern is configured such that bands of at least two of the at least one physical signal block included in the physical signal cluster do not completely overlap.

In some aspects, for example, the frequency hopping pattern is configured such that there is no gap between adjacent bands of the bands allocated to the at least one physical signal block included in the physical signal cluster.

In some aspects, for example, the frequency-domain mapping is configured such that the sequence of each physical signal block of the physical signal cluster is mapped to a subcarrier at a center of a band allocated for the physical signal block.

In some aspects, for example, the physical signal cluster is a downlink signal, and the configuration information further includes a first configuration that Q consecutive time-domain symbols after a last time-domain symbol of any physical signal block or a last physical signal block in the physical signal cluster are not available for uplink physical channels and/or uplink physical signals, where Q is an integer greater than or equal to 1.

In some aspects, for example, the physical signal cluster is an uplink signal, and the configuration information further includes a second configuration that Q′ consecutive time-domain symbols after the last time-domain symbol of any physical signal block or the last physical signal block in the physical signal cluster are not available for downlink physical channels and/or downlink physical signals, where Q′ is an integer greater than or equal to 1.

In some aspects, for example, when the first configuration is enabled, it is determined that the Q consecutive time-domain symbols after the last time-domain symbol of any physical signal block or the last physical signal block in the physical signal cluster are not available for uplink physical channels and/or uplink physical signals.

In some aspects, for example, when the second configuration is enabled, it is determined that the Q′ consecutive time-domain symbols after the last time-domain symbol of any physical signal block or the last physical signal block in the physical signal cluster are not available for downlink physical channels and/or downlink physical signals.

In some aspects, for example, the physical signal cluster is a downlink signal, and the configuration information further includes a third configuration that P consecutive time-domain symbols after the last time-domain symbol of any physical signal block or the last physical signal block in the physical signal cluster are neither available for uplink physical channels and/or uplink physical signals nor for downlink physical channels and/or downlink physical signals, where P is an integer greater than or equal to 1.

In some aspects, for example, the physical signal cluster is an uplink signal, and the configuration information further includes a fourth configuration that P′ consecutive time-domain symbols after the last time-domain symbol of any physical signal block or the last physical signal block in the physical signal cluster are neither available for uplink physical channels and/or uplink physical signals nor for downlink physical channels and/or downlink physical signals, where P′ is an integer greater than or equal to 1.

In some aspects, for example, when the third configuration is enabled, the P consecutive time-domain symbols after the last time-domain symbol of any physical signal block or the last physical signal block in the physical signal cluster are neither available for uplink physical channel and/or uplink physical signal nor for downlink physical channel and/or downlink physical signal.

In some aspects, for example, when the fourth configuration is enabled, the P′ consecutive time-domain symbols after the last time-domain symbol of any physical signal block or the last physical signal block in the physical signal cluster are neither available for uplink physical channels and/or uplink physical signals nor for downlink physical channels and/or downlink physical signals.

In some aspects, for example, one or more frequency-domain resources adjacent to a band allocated to each physical signal block of the physical signal cluster are neither available for uplink physical channels and/or uplink physical signals nor for downlink physical channels and/or downlink physical signals.

In some aspects, for example, the determining of the configuration information on the at least one physical signal cluster includes receiving the configuration information on the at least one physical signal cluster via a radio resource control (RRC) message, a downlink control information (DCI) message or a combination thereof.

In some aspects, for example, the method further includes transmitting the configuration information on the at least one physical signal cluster via a radio resource control (RRC) message, a downlink control information (DCI) message or a combination thereof.

In some aspects, for example, the physical signal block is generated by mapping the sequence to a plurality of subcarriers on a time-domain symbol.

In some aspects, for example, a difference of indexes of adjacent subcarriers of the plurality of subcarriers on the time-domain symbol to which the sequence is mapped is 2*k, where k is a non-zero integer.

In some aspects, for example, the at least one physical signal block is consecutive in time.

In some aspects, for example, the physical signal block includes the N repetitions of the sequence in at least one consecutive time-domain symbol.

In some aspects, for example, a number of the at least one consecutive time-domain symbol is N.

In some aspects, for example, when the physical signal block is generated, a cyclic prefix is added only before a first repetition of N repetitions of the sequence, and/or a length of the cyclic prefix of the physical signal block is equal to a sum of a length of a cyclic prefix of each of at least one consecutive time-domain symbol occupied by the physical signal block.

In some aspects, for example, a number of the at least one consecutive time domain symbol is 1.

In some aspects, for example, the transmitting of the at least one physical signal cluster includes transmitting the at least one physical signal cluster using a same spatial domain transmission filter.

In some aspects, for example, the transmitting of the at least one physical signal cluster includes transmitting the at least one physical signal cluster using different spatial domain transmission filters.

In accordance with another aspect of the disclosure, a method performed by a communication apparatus in a wireless communication system is provided. The method includes determining configuration information on at least one physical signal cluster, and transmitting the configuration information on the at least one physical signal cluster, wherein the physical signal cluster includes at least one physical signal block, and the physical signal block includes N repetitions of a sequence, where N is an integer greater than or equal to 1.

In accordance with another aspect of the disclosure, a communication apparatus in a wireless communication system is provided. The communication apparatus includes a transceiver, one or more processors communicatively coupled with the transceiver; and memory storing one or more computer programs including computer-executable instructions that, when executed by the one or more processors, cause the communication apparatus to determine configuration information on at least one physical signal cluster, and transmit the at least one physical signal cluster based on the configuration information on the at least one physical signal cluster, wherein the physical signal cluster includes at least one physical signal block, wherein the physical signal block includes N repetitions of a sequence, and wherein the N is an integer greater than or equal to 1.

In accordance with another aspect of the disclosure one or more non-transitory a computer-readable storage media storing one or more computer programs including computer-executable instructions that, when executed by one or more processors of a communication apparatus, cause the communication apparatus to perform operations are provided. The operations include determining configuration information on at least one physical signal cluster; and transmitting the at least one physical signal cluster based on the configuration information on the at least one physical signal cluster, wherein the physical signal cluster includes at least one physical signal block, wherein the physical signal block includes N repetitions of a sequence, and wherein the N is an integer greater than or equal to 1

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying the drawings, in which:

FIG. 1 illustrates a schematic diagram of an example wireless network according to an embodiment of the disclosure;

FIGS. 2A and 2B illustrate example wireless transmission and reception paths according to various embodiments of the disclosure;

FIG. 3A illustrates an example of a user equipment (UE) according to an embodiment of the disclosure;

FIG. 3B illustrates an example of a gNB according to an embodiment of the disclosure;

FIG. 4A illustrates an example of a sensing signal block according to an embodiment of the disclosure;

FIG. 4B illustrates an example of a sensing signal block according to an embodiment of the disclosure;

FIG. 5 illustrates a schematic diagram of frequency hopping transmission of a sensing signal according to an embodiment of the disclosure;

FIG. 6 illustrates a schematic diagram of a second time interval in case that a sensing signal is an uplink signal according to an embodiment of the disclosure;

FIG. 7 illustrates a schematic diagram of periodic sensing signal transmission according to an embodiment of the disclosure;

FIG. 8 illustrates a schematic diagram of periodic sensing signal transmission according to an embodiment of the disclosure;

FIG. 9 illustrates a flowchart of a method performed by a communication apparatus in a wireless communication system according to an embodiment of the disclosure;

FIG. 10 illustrates a flowchart of a method performed by a communication apparatus in a wireless communication system according to an embodiment of the disclosure;

FIG. 11 illustrates a block diagram of a terminal according to an embodiment of the disclosure; and

FIG. 12 illustrates a block diagram of a base station according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In order to make the purpose, technical schemes and advantages of the embodiments of the disclosure clearer, the technical schemes of the embodiments of the disclosure will be described clearly and completely with reference to the drawings of the embodiments of the disclosure. The described embodiments are a part of the embodiments of the disclosure, but not all embodiments. Based on the described embodiments of the disclosure, all other embodiments obtained by those of ordinary skill in the art without creative labor belong to the protection scope of the disclosure.

Foremost, it can be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, connect to, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller can be centralized or distributed, whether locally or remotely. The phrase “at least one of,” when used with a list of items, means that different combinations of one or more of the listed items can be used, and only one item in the list may be needed. For example, “at least one of: A, B, and C” includes any of the following combinations: A, B, C, A and B, A and C, B and C, and A and B and C. For example, “at least one of: A, B, or C” includes any of the following combinations: A, B, C, A and B, A and C, B and C, and A, B and C.

Various functions described below may be implemented or supported by one or more computer programs, each of which is formed from computer-readable program code and embodied in a computer-readable medium. The terms “application” and “program” refer to one or more computer programs, software components, sets of instructions, procedures, functions, objects, classes, instances, related data, or a portion thereof adapted for implementation in a suitable computer-readable program code. The phrase “computer-readable program code” includes any type of computer code, including source code, object code, and executable code. The phrase “computer-readable medium” includes any type of medium capable of being accessed by a computer, such as Read-Only Memory (ROM), Random Access Memory (RAM), a hard disk drive, a Compact Disc (CD), a Digital Video Disc (DVD), or any other type of memory. A “non-transitory” computer-readable medium excludes wired, wireless, optical, or other communication links that transport transitory electrical or other signals. A non-transitory computer-readable medium includes media where data may be permanently stored and media where data may be stored and later overwritten, such as a rewritable optical disc or an erasable memory device.

Terms used herein to describe the embodiments of the disclosure are not intended to limit and/or define the scope of the disclosure. For example, unless otherwise defined, the technical terms or scientific terms used in the disclosure shall have the ordinary meaning understood by those with ordinary skills in the art to which the disclosure belongs.

It should be understood that “first”, “second” and similar words used in the disclosure do not express any order, quantity or importance, but are only used to distinguish different components. For example, reference to “a component surface” includes reference to one or more of such surfaces.

As used herein, any reference to “an example” or “example”, “an implementation” or “implementation”, “an embodiment” or “embodiment” means that particular elements, features, structures or characteristics described in connection with the embodiment is included in at least one embodiment. The phrases “in one embodiment” or “in one example” appearing in different places in the specification do not necessarily refer to the same embodiment.

As used herein, “a portion of” something means “at least some of” the thing, and as such may mean less than all of, or all of, the thing. Accordingly, “a portion of” a thing includes the entire thing as a special case, i.e., the entire thing is an example of a portion of the thing.

As used herein, the term “set” means one or more. Accordingly, a set of items can be a single item or a collection of two or more items.

To determine whether a specific condition is satisfied or fulfilled, expressions, such as “greater than” or “less than” are used by way of example and expressions, such as “greater than or equal to” or “less than or equal to” are also applicable and not excluded. In an example, a condition defined with “greater than or equal to” may be replaced by “greater than” (or vice-versa), a condition defined with “less than or equal to” may be replaced by “less than” (or vice-versa), etc.

Additionally, t will be understood that similar words such as the term “include” or “comprise” mean that elements or objects appearing before the word encompass the listed elements or objects appearing after the word and their equivalents, but other elements or objects are not excluded. Similar words such as “connect” or “connected” are not limited to physical or mechanical connection, but can include electrical connection, whether direct or indirect. “Upper”, “lower”, “left” and “right” are only used to express a relative positional relationship, and when an absolute position of the described object changes, the relative positional relationship may change accordingly.

The embodiments discussed below for describing the principles of the disclosure in the patent document are for illustration only and should not be interpreted as limiting the scope of the disclosure in any way. Those skilled in the art will understand that the principles of the disclosure can be implemented in any suitably arranged wireless communication system. For example, although the following detailed description of the embodiments of the disclosure will be directed to long term evolution (LTE) and/or 5G communication systems, those skilled in the art will understand that the main points of the disclosure can also be applied to other communication systems with similar technical backgrounds and channel formats with slight modifications without departing from the scope of the disclosure. The technical schemes of the embodiments of the application may be applied to various communication systems, and for example, the communication systems may include global systems for mobile communications (GSM), code division multiple access (CDMA) systems, wideband code division multiple access (WCDMA) systems, general packet radio service (GPRS) systems, long term evolution (LTE) systems, LTE frequency division duplex (FDD) systems, LTE time division duplex (TDD) systems, universal mobile telecommunications system (UMTS), worldwide interoperability for microwave access (WiMAX) communication systems, 5th generation (5G) systems or new radio (NR) systems, etc. Additionally, the technical schemes of the embodiments of the application can be applied to future-oriented communication technologies. In addition, the technical schemes of the embodiments of the application may be applied to future-oriented communication technologies.

The embodiments of the disclosure will be described in detail with reference to the accompanying drawings. It should be noted that the same reference numerals in different drawings will be used to refer to the same elements already described.

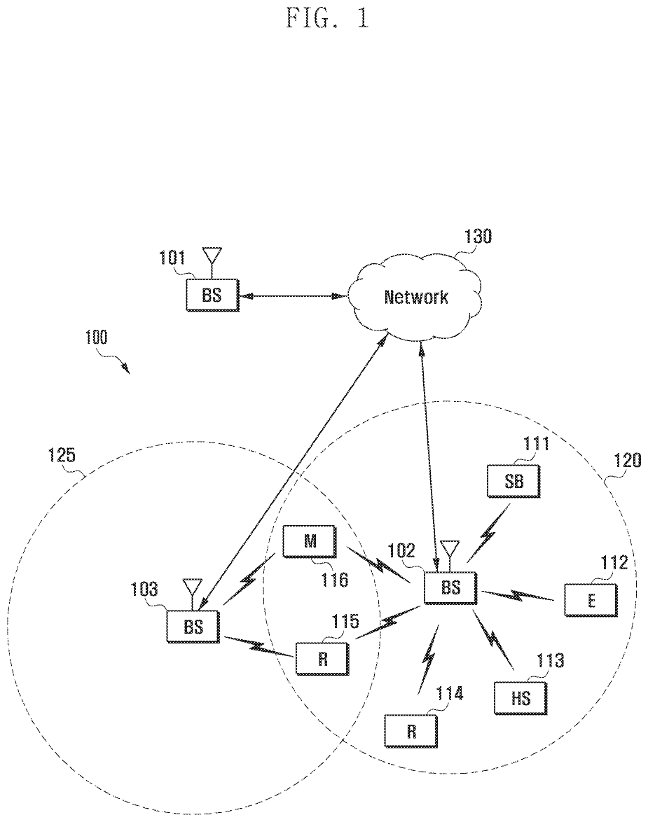

The following FIGS. 1, 2A, 2B, 3A, and 3B describe various embodiments implemented by using orthogonal frequency division multiplexing (OFDM) or orthogonal frequency division multiple access (OFDMA) communication technologies in wireless communication systems. The descriptions of FIGS. 1, 2A, 2B, 3A, and 3B do not mean physical or architectural implications for the manner in which different embodiments may be implemented. Different embodiments of the disclosure may be implemented in any suitably arranged communication systems.

It should be appreciated that the blocks in each flowchart and combinations of the flowcharts may be performed by one or more computer programs which include instructions. The entirety of the one or more computer programs may be stored in a single memory or the one or more computer programs may be divided with different portions stored in different multiple memories.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphical processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

FIG. 1 illustrates an example wireless network 100 according to an embodiment of the disclosure.

The embodiment of a wireless network 100 shown in FIG. 1 is for illustration only. Other embodiments of the wireless network 100 may be used without departing from the scope of the disclosure.

A wireless network 100 includes a gNodeB (gNB) 101, a gNB 102, and a gNB 103. The gNB 101 communicates with the gNB 102 and the gNB 103. The gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For example, the terms “terminal”, “user equipment” and “UE” may be used in this document to refer to remote wireless devices that wirelessly access the gNB, no matter whether the UE is a mobile device (such as a mobile phone or a smart phone) or a fixed device (such as a desktop computer or a vending machine).

The gNB 102 provides wireless broadband access to the network 130 for a first plurality of User Equipments (UEs) within a coverage area 120 of the gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. the gNB 103 provides wireless broadband access to network 130 for a second plurality of UEs within a coverage area 125 of the gNB 103. The second plurality of UEs include a UE 115 and a UE 116. In some embodiments, one or more of the gNBs 101-103 can communicate with each other and with UEs 111-116 using 5G, Long Term Evolution (LTE), long term evolution advanced (LTE-A), worldwide interoperability for microwave access (WiMAX) or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of the gNB 101, the gNB 102, and the gNB 103 include a two-dimensional (2D) antenna array as described in embodiments of the disclosure. In some embodiments, one or more of the gNB 101, the gNB 102, and the gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, the gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, the gNB 101, the gNB 102 and/or the gNB 103 can provide access to other or additional external networks, such as external telephone networks or other types of data networks.

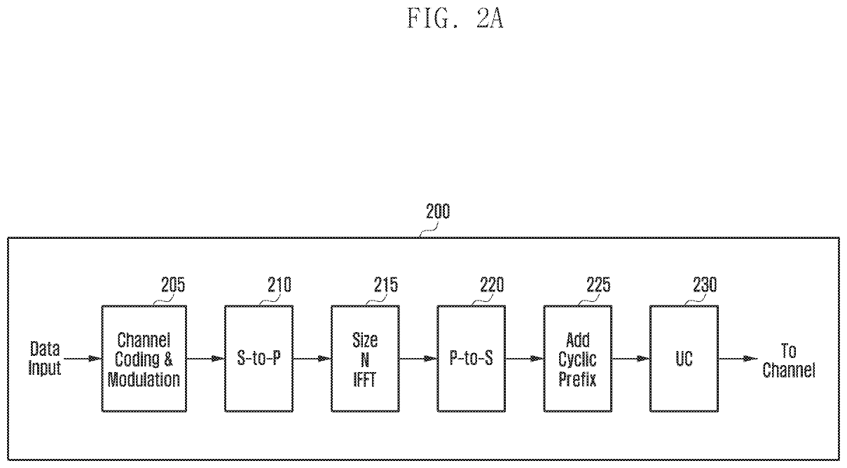

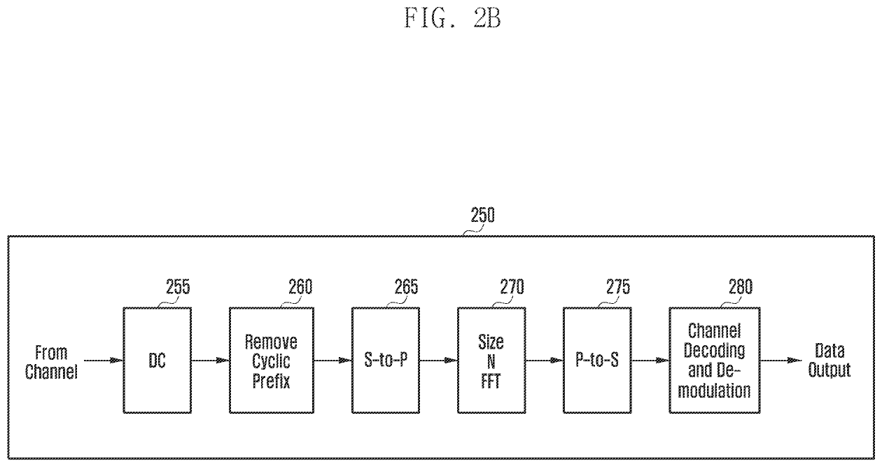

FIGS. 2A and 2B illustrate example wireless transmission and reception paths according to various embodiments of the disclosure. In the following description, a transmission path 200 may be described as being implemented in a gNB, such as a gNB 102, and a reception path 250 can be described as being implemented in a UE, such as a UE 116. However, it should be understood that the reception path 250 can be implemented in a gNB and the transmission path 200 may be implemented in a UE. In some embodiments, the reception path 250 is configured to support codebook designs and structures for systems with 2D antenna arrays as described in embodiments of the disclosure.

In an embodiment, the transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. In another embodiment, the reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. In an example, the Serial-to-Parallel (S-to-P) block 210 converts (such as demultiplexes) serial modulated symbols into parallel data to generate N parallel symbol streams, where N is a size of the IFFT/FFT used in the gNB 102 and UE 116. The size N IFFT block 215 performs IFFT operations on the N parallel symbol streams to generate a time-domain output signal. In another example, the Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal may also be filtered at a baseband before switching to the RF frequency.

The RF signal transmitted from the gNB 102 arrives at UE 116 after passing through the wireless channel, and operations in reverse to those at the gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts, for example, the parallel frequency-domain signal into a sequence of modulated data symbols. The channel decoding and demodulation block 280 demodulates and decodes the modulated symbols to recover the original input data stream.

Each of the gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to the gNBs 101-103 in the uplink, and may implement a reception path 250 for receiving from the gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. The FFT block 270 and IFFT block 215 may be implemented as configurable software algorithms, in which the value of the size N may be modified according to the implementation.

Although described as using FFT and IFFT, this is only illustrative and should not be interpreted as limiting the scope of the disclosure. Other types of transforms may be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components may be added according to specific requirements. FIGS. 2A and 2B are intended to illustrate examples of types of transmission and reception paths that can be used in a wireless network. Any other suitable architecture may be used to support wireless communication in a wireless network.

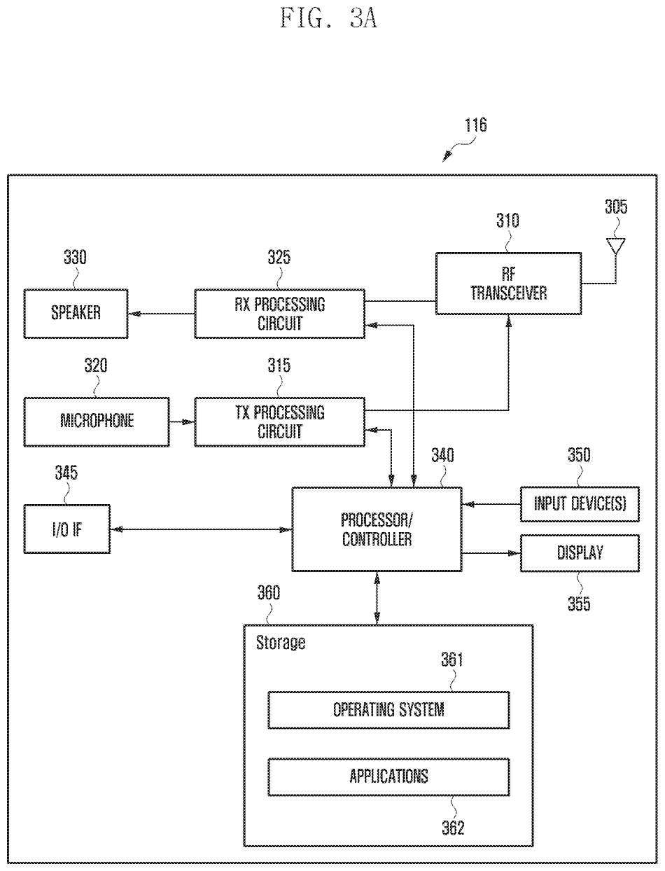

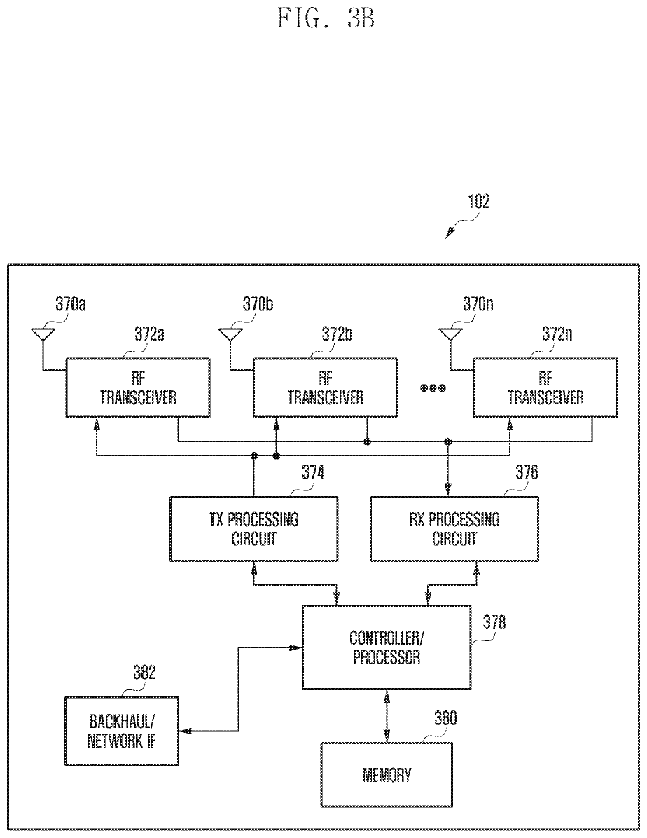

FIG. 3A illustrates an example of a UE 116 according to an embodiment of the disclosure.

The embodiment of the UE 116 shown in FIG. 3A is for illustration only, and the UEs 111-115 of FIG. 1 can have the same or similar configuration. However, a UE has various configurations, and FIG. 3A does not limit the scope of the disclosure to any specific implementation of the UE.

The UE 116 includes an antenna 305, a radio frequency (RF) transceiver 310, a transmission (TX) processing circuit 315, a microphone 320, and a reception (RX) processing circuit 325. The UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. In another embodiment, the RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. In another embodiment, the TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 may include one or more processors or other processing devices and execute an OS 361 stored in the memory 360 in order to control the overall operation of the UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 may also be capable of executing other processes and programs residing in the memory 360, such as operations for channel quality measurement and reporting for systems with 2D antenna arrays as described in embodiments of the disclosure. The processor/controller 340 can move data into or out of the memory 360 as required by an execution process. In various embodiments, the processor/controller 340 is configured to execute the application 362 based on the OS 361 or in response to signals received from the gNB or the operator. The processor/controller 340 is also coupled to an I/O interface 345, where the I/O interface 345 provides the UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of the UE 116 can input data into the UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of the UE 116, various changes can be made to FIG. 3A. Various components in FIG. 3A can be combined, further subdivided or omitted, and additional components may be added according to specific requirements. As a specific example, the processor/controller 340 may be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example of a gNB 102 according to an embodiment of the disclosure. The embodiment of the gNB 102 shown in FIG. 3B is for illustration only, and other gNBs of FIG. 1 can have the same or similar configuration. However, a gNB has various configurations, and FIG. 3B does not limit the scope of the disclosure to any specific implementation of a gNB. It should be noted that a gNB 101 and a gNB 103 can include the same or similar structures as the gNB 102.

Referring to FIG. 3B, the gNB 102 includes a plurality of antennas 370a-370n (i.e., 370a, 370b . . . 370n), a plurality of RF transceivers 372a-372n (i.e., 372a, 372b . . . 372n), a transmission (TX) processing circuit 374, and a reception (RX) processing circuit 376. In certain embodiments, one or more of the plurality of antennas 370a-370n include a 2D antenna array. The gNB 102 also includes a controller/processor 378, a memory 380, and a backhaul or network interface 382.

The RF transceivers 372a-372n receive an incoming RF signal from antennas 370a-370n, such as a signal transmitted by UEs or other gNBs. The RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. The RX processing circuit 376 transmits the processed baseband signal to controller/processor 378 for further processing.

The TX processing circuit 374 receives analog or digital data (such as voice data, network data, email or interactive video game data) from the controller/processor 378. The TX processing circuit 374 encodes, multiplexes and/or digitizes outgoing baseband data to generate a processed baseband or IF signal. The RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of the gNB 102. In an example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. The controller/processor 378 can perform a Blind Interference Sensing (BIS) process such as that performed through a BIS algorithm, and decode a received signal from which an interference signal is subtracted. A controller/processor 378 may support any of a variety of other functions in the gNB 102. In some embodiments, the controller/processor 378 includes at least one microprocessor or microcontroller.

The controller/processor 378 is also capable of executing programs and other processes residing in the memory 380, such as a basic OS. The controller/processor 378 may also support channel quality measurement and reporting for systems with 2D antenna arrays as described in embodiments of the disclosure. In some embodiments, the controller/processor 378 supports communication between entities such as web RTCs. The controller/processor 378 may move data into or out of the memory 380 as required by an execution process.

The controller/processor 378 is also coupled to the backhaul or the network interface 382. The backhaul or network interface 382 allows the gNB 102 to communicate with other devices or systems through a backhaul connection or through a network. The backhaul or the network interface 382 can support communication over any suitable wired or wireless connection(s). For example, when the gNB 102 is implemented as a part of a cellular communication system, such as a cellular communication system supporting 5G or new radio access technology or NR, LTE or LTE-A, the backhaul or network interface 382 can allow the gNB 102 to communicate with other gNBs through wired or wireless backhaul connections. When the gNB 102 is implemented as an access point, the backhaul or network interface 382 can allow the gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

The transmission and reception paths of the gNB 102 (implemented using RF transceivers 372a-372n, TX processing circuit 374 and/or RX processing circuit 376) support aggregated communication with FDD cells and TDD cells.

Although FIG. 3B illustrates an example of the gNB 102, various changes may be made to FIG. 3B. For example, the gNB 102 can include any number of each component shown in FIG. 3A. The access point can include many backhaul or network interfaces 382, and the controller/processor 378 can support routing functions to route data between different network addresses. As another specific example, although shown as including a single instance of the TX processing circuit 374 and a single instance of the RX processing circuit 376, the gNB 102 can include multiple instances of each (such as one for each RF transceiver).

Unless defined differently, all terms used herein, which include technical terminologies or scientific terminologies, have the same meaning as that understood by a person skilled in the art to which the disclosure belongs. Accordingly, such terms as those defined in a generally used dictionary are to be interpreted to have the meanings equal to the contextual meanings in the relevant field of art, and are not to be interpreted to have ideal or excessively formal meanings unless clearly defined in the disclosure.

The technical schemes of the embodiments of the disclosure may be applied to various communication systems, such as global systems for mobile communications (GSM), code division multiple access (CDMA) systems, wideband code division multiple access (WCDMA) systems, general packet radio service (GPRS) systems, long term evolution (LTE) systems, LTE frequency division duplex (FDD) systems, LTE time division duplex (TDD) systems, universal mobile telecommunications systems (UMTS), worldwide interoperability for microwave access (WiMAX) communication systems, 5th generation (5G) systems or new radio (NR) systems, etc. In addition, the technical schemes of the embodiments of the application can be applied to future-oriented communication technologies.

It should be noted that, in embodiments of the disclosure, parameters, information or configurations may be preconfigured or predefined or configured by a base station. In some cases, parameters, information or configurations may be referred to as predefined parameters, predefined information or predefined configurations, respectively. In embodiments of the disclosure, the meaning of preconfiguring certain information or parameters in a UE may be interpreted as default information or parameters embedded in the UE when manufacturing the UE, or information or parameters pre-acquired through higher layer signaling (e.g., RRC) configuration and stored in the UE, or information or parameters acquired and stored from the base station. In other embodiments of the disclosure, parameters, information or configurations may be configured through higher layer signaling (e.g., RRC), physical layer signaling (e.g., downlink control information (DCI)) or a combination thereof. For example, when configured by a combination of an RRC message and a DCI message, one or more parameters or configurations may be configured by the RRC message, and the corresponding parameters or configurations may be activated/enabled or deactivated/disabled by the DCI message.

With the advancement of science and technology, there are more and more diverse communication devices. In addition to traditional mobile phones, computers and other devices, such communication devices may also include mobile robots such as autonomous vehicles and drones. This type of mobile devices need to have the capability of positioning itself or being positioned with a high accuracy, in order to accurately identify and react to the current situation. They need to have the positioning capability similar to that provided by radar technologies. This may be achieved directly by equipping the communication device with a radar module. However, with the gradual development of the operating band of a communication system to a higher band in recent years, the communication band is gradually approaching the radar band, resulting in an inevitable interference and a resource conflict between a communication system and a radar system. To solve this problem, it has been considered to integrate a communication device and a radar into a single system, called a communication-sensing integration technology, to further enhance functions of the communication system and improve the spectral efficiency. At present, both the industry and the academia have regarded the communication-sensing integration as one of the key technologies of future communication systems.

A core concept of communication-sensing integration is to use a same set of hardware devices to sense the surrounding environment at as little resource overhead as possible on the premises of ensuring basic communication functions. In an embodiment, the sensing includes sensing a distance, an orientation, a speed or even a type of an object or subject in the surrounding environment. Different from the technology of positioning an accessed terminal in a traditional communication system, the communication-sensing integration technology may also sense a variety of information of an object or subject that has not accessed, which greatly increases the capability of a communication system to dynamically adjust (provide scheduling, beam management, early warning of access terminals, and/or the like) the operating state thereof according to the surrounding environment.

At present, the most widely used communication systems are systems based on 3rd generation partnership project (3GPP) protocols, such as fourth generation (4G) communication systems such as LTE and LTE-A systems, and 5G communication systems such as NR systems, where the signal waveforms used in these communication systems are waveforms modulated based on OFDM. Studies have shown that a communication signal based on a OFDM waveform may perform better as a sensing signal. It is feasible to consider adding a sensing function to an existing 4G/5G communication system to realize the integration of communication and sensing. To integrate a sensing function into a communication system, the key is that a receiver of a communication-sensing node needs to support detection of an echo of the sensing signal, that is, echo signal detection, where the echo refers to a process where the sensing signal transmitted by the Communication-sensing node, after reaching a target object, is reflected back to the receiving end of the Communication-sensing node by a surface of the target object. After receiving the echo signal, the Communication-sensing node processes (detects, estimates, and/or the like) the signal, and obtains a sensing result such as a distance between the target object and the Communication-sensing node, a radial velocity and an angular velocity of the target object. The sensing process described is actually a process of receiving, detecting and estimating a signal. In order to improve the sensing performance and accurately estimate the distance and speed of the target object, the sensing signal needs to have specific characteristics. In order to sense a target object at a longer distance, the sensing signal needs to have a cyclic prefix larger than that supported by a design of existing systems (e.g., LTE, LTE-A, NR, etc.); for another example, in order to sense the speed of a target, the sensing signal needs to be consecutively transmitted for many times at equal intervals in a period of time. Communication signals supported by existing protocols, including physical channels and physical signals, cannot satisfy requirements of sensing at the same time.

According to embodiments, a configuration and transmission method of a physical signal is proposed, which, for example, may be used for a sensing purpose to improve sensing performance of characteristics such as a target distance and a speed. For convenience of description, the physical signal for sensing proposed in the disclosure will be referred to as a sensing signal. However, the embodiments of the disclosure are not limited to this, and the proposed physical signal may also be used for other purposes, such as echo detection for non-sensing purposes, which should be within the protection scope of the disclosure. For example, the sensing signal described in the disclosure may be at least one of: an uplink/downlink sensing dedicated signal, an uplink/downlink sensing dedicated signal, an uplink/downlink shared channel, an uplink/downlink control channel, a CSI-RS, a SRS, a SSB, etc. In the various embodiments of the disclosure, a communication-sensing node that transmits a physical signal (e.g., a sensing signal) may include a terminal or a network node (e.g., a base station). In some examples, a base station serving as a communication-sensing node transmits a physical signal (e.g., a sensing signal), and a terminal serving as a target object receives or does not receive the physical signal (e.g., the sensing signal). In other examples, a terminal serving as a communication-sensing node transmits a physical signal (e.g., a sensing signal), and a base station serving as a target object receives or does not receive the physical signal. In yet other examples, a terminal serving as a communication-sensing node transmits a physical signal (e.g., a sensing signal), and another terminal serving as a target object receives or does not receive the physical signal (e.g., the sensing signal). The embodiments of the disclosure may be applied to various communication scenarios, including but not limited to, a scenario in which a base station communicates with a terminal, a scenario in which a base station communicates with another base station, or a scenario in which a terminal communicates with another terminal. In the embodiments of the disclosure, configuring a physical signal (e.g., a sensing signal) may include determining time-domain resources and/or frequency-domain resources of the physical signal (e.g., the sensing signal). In the embodiments of the disclosure, generating a physical signal (e.g., a sensing signal) may include generating a sequence of the physical signal (e.g., the sensing signal), and/or determining resources (e.g., time-frequency resources, including time-domain resources and/or frequency-domain resources) of the physical signal (e.g., the sensing signal), and/or mapping the physical signal (e.g., the sequence thereof) to the resources. In the embodiments of the disclosure, the time-domain resources may include symbols (e.g., OFDM symbols), slots, mini-slots or subframes, etc., and the frequency-domain resources may include channels, subchannels, carriers or subcarriers, etc.

In the configuration and transmission method of the physical signal according to some embodiments of the disclosure, the physical signal (e.g., the sensing signal) includes at least one physical signal block (e.g., sensing signal block), where a corresponding physical signal block (e.g., a sensing signal block) of the at least one physical signal block is generated based on or includes N repetitions of a sequence (e.g., N repetitions on at least one consecutive time unit (e.g., symbol). In an example, N is a predefined value or configurable (for example, by a base station). As another example, N is a positive integer greater than or equal to 1, such as 1, 2, 3, . . . . The sequence may be or be generated based on a pseudo-random sequence (e.g., an M sequence or a Gold sequence). In some examples, the physical signal (e.g., the sensing signal) includes at least one physical signal block (e.g., sensing signal block) configured to be consecutively transmitted in a period of time, where a corresponding physical signal block of the at least one physical signal block (e.g., sensing signal block) is configured to repeatedly transmit a same sequence for N times on at least one consecutive time-domain symbol. It should be noted that, in the embodiments of the disclosure, the at least one physical signal block (e.g., sensing signal block) of the physical signal (e.g., the sensing signal) may be the same as each other or different from each other (for example, generated based on different sequences). In the embodiments of the disclosure, for example, if S_A is repeated once, there is one S_A, and if S_A is repeated for N times (or S_A has N repetitions), there are N S_As; therefore, the sequence is repeated for N times (or the sequence has N repetitions), indicating that there are N such sequences, so that the sequence is transmitted for N times. In the embodiments of the disclosure, when a terminal (for example, the terminal serving as a communication-sensing node) transmits a physical signal (e.g., a sensing signal), the physical signal (e.g., the sensing signal) is an uplink signal and the corresponding transmission is an uplink transmission, and in this case, the physical signal (e.g., the sensing signal) may be or may not be received by a base station; when a base station (for example, the base station serving as a communication-sensing node) transmits a physical signal (e.g., a sensing signal), the physical signal (e.g., the sensing signal) is a downlink signal and the corresponding transmission is a downlink transmission, and in this case, the physical signal (e.g., the sensing signal) may be or may not be received by a terminal. In the following description, a “sensing signal” will be taken as an example of a “physical signal”. Furthermore, a “time-domain symbol” (e.g., OFDM symbol) will be described as an example of a “time unit”. However, the embodiments of the disclosure are not limited to this, and the time unit may be any suitable time unit, such as a subframe, a slot or a mini-slot.

In some embodiments, a number of time-domain symbols included in the sensing signal block (for example, time-domain symbols where the sensing signal block is located) is N (that is, equals to a number of repetitions of a sequence in the sensing signal block), that is, for the sensing signal block, a same sequence is repeatedly transmitted on N consecutive time-domain symbols for N times. For example, N repetitions of the sequence of the sensing signal block are located in N consecutive time-domain symbols, respectively. In examples, a time-domain signal generated based on a same sequence may be consecutively repeated for N times in an end-to-end manner, and a cyclic prefix (CP) may be added before the first transmission (i.e., the first repetition) of the N repetitions to constitute a time-domain baseband signal of the sensing signal block. The cyclic prefix may be added only before the first repetition of the N repetitions of the time-domain signal, and/or the cyclic prefix may not be added before other repetitions except the first repetition of N repetitions, that is, the time-domain signal with N repetitions may be located in multiple time-domain symbols (when N is greater than 1), but there is only one cyclic prefix. As another example, a length of the cyclic prefix of the sensing signal block is a sum of a length of a cyclic prefix of each symbol occupied by the sensing signal block. The process of generating the time-domain signal of the sensing signal block based on the same sequence may include mapping the sequence on different subcarriers in a same time unit, and performing IFFT transformation on a frequency-domain signal of the sequence to obtain the time-domain signal of the sequence, where a size of IFFT may be determined by a subcarrier spacing configured for the time-domain symbols included in the sensing signal block.

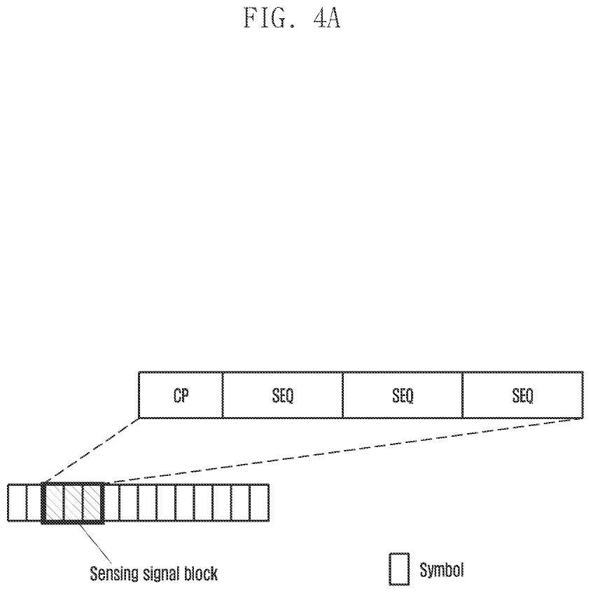

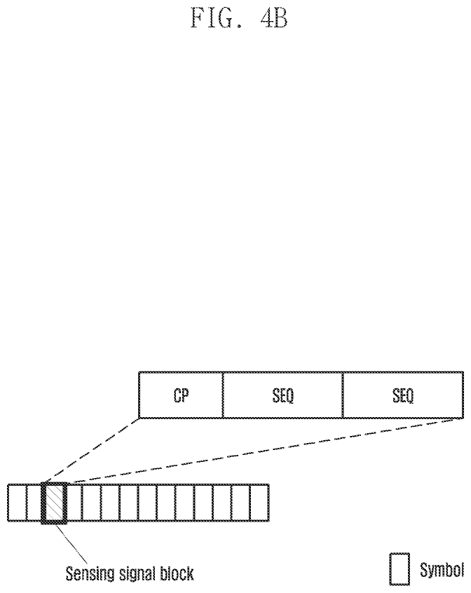

FIG. 4A illustrates an example of a sensing signal block according to an embodiment of the disclosure, where N=3.

Referring to FIG. 4A, the sensing signal block occupies three consecutive time-domain symbols, and a time-domain signal generated based on a sequence SEQ is repeated for three times end to end, and a cyclic prefix is added before a time-domain signal where the first repetition is located. This design can take the previous repetition of the same sequence as an equivalent cyclic prefix of the next repetition, which greatly increases the coverage of sensing; or, when a target object is close and can be covered by adopting a length of the cyclic prefix of the sensing signal block itself, the repetitions of the sequence may be combined at the receiving end to improve the signal-to-noise ratio of sensing detection. Therefore, the design may be used to support the sensing detection of far distance targets and near distance targets. In the embodiments of the disclosure, the term “sensing detection” may refer to a process of transmitting a sensing signal and/or a process of detecting an echo signal.

In some implementations, a number of time-domain symbols included in the sensing signal block (for example, time-domain symbols where the sensing signal block is located) is 1, that is, a same sequence is repeatedly transmitted for N times on a single time-domain symbol. For example, N repetitions of the sequence of the sensing signal block are located in the single time-domain symbol.

FIG. 4B illustrates an example of a sensing signal block according to an embodiment of the disclosure.

Referring to FIG. 4B, two repetitions of a sequence SEQ of the sensing signal block are located in a single time-domain symbol. The sensing signal block may be, for example, configured with a subcarrier spacing. When the number of the time-domain symbols included in the sensing signal block (for example, the time-domain symbols where the sensing signal block is located) is 1, the sensing signal block may be configured with a smaller subcarrier spacing, and at this time, a length of the single time-domain symbol occupied by the sensing signal block is a symbol length corresponding to the smaller subcarrier spacing and is greater than a length of other time-domain symbols in the slot. A subcarrier to which the sequence is mapped may be configured so that the sequence is repeatedly transmitted for N times on the single time-domain symbol, for example, N is an even number. In some examples, on the time-domain symbol configured for the sensing signal block, the sequence is mapped to a subcarrier with an even index, and a spacing of subcarriers to which adjacent elements of the sequence are mapped is a power of 2 (for example, 2\hat{ }η,η=1, 2, . . . ) in subcarriers, and the remaining subcarriers on the time-domain symbols configured for the sensing signal block are not used for uplink and downlink transmission mapping. As a specific example, a spacing of subcarrier to which the adjacent elements of the sequence of the sensing signal block are mapped may be 4 subcarriers. The sequence may be mapped to a subcarrier with an index of 4n (n=0, 1, 2 . . . ) or on a subcarrier with an index of 4n+2 (n=0, 1, 2 . . . ); and as another specific example, a spacing of subcarriers to which the adjacent elements of the sequence of the sensing signal block are mapped may be 2 subcarriers, and the sequence may be mapped to a subcarrier with an index 2n (n=0, 1, 2 . . . ). The generation process of the time-domain baseband signal on the sensing signal block may include performing IFFT transformation on the frequency-domain signal of the sequence of the sensing signal block to obtain the time-domain signal of the sequence, and adding a cyclic prefix before the time-domain signal. According to the nature of Fourier transform, the sequence with this frequency-domain mapping is N end-to-end repetitions of the same time-domain signal in time domain, so that the time-domain signal of the sensing signal block as shown in FIG. 4B (an example of N=2) may be constructed. Therefore, the sensing signal block can simultaneously support the sensing detection of far distance targets and near distance targets. As a simplified form, when the value of N is 1, the sensing signal block may be a transmission unit where the same sequence is transmitted once on a time-domain symbol. The sensing signal block in this configuration may be used for the sensing detection of near distance targets and is compatible with existing reference signals, such as SRS, CSI-RS, etc., that is, the existing reference signals may be configured for sensing purposes.

According to various embodiments of the disclosure, at least one sensing signal block (e.g., multiple sensing signal blocks) included in the sensing signal may be transmitted in a frequency hopping manner on different bands. For example, the band used for transmission of each sensing signal block may be determined according to the frequency hopping pattern. As another example, the frequency hopping pattern may be configured or predefined such that the bands for transmission of at least two or more sensing signal blocks do not completely overlap within the transmission duration of the sensing signal. The purpose of this design is to avoid deep fading in a single band, which will affect the sensing performance. At the same time, the sensing signal blocks transmitted in different bands may be combined and detected, which may be equivalent to the sensing effect in a larger bandwidth after the bands of these sensing signal blocks are concatenated, thereby improving the sensing performance such as target distance resolution. In an example, the frequency hopping pattern may be configured or predefined such that a sum of bands used for frequency hopping transmission of all sensing signal blocks constitutes a consecutive bandwidth in frequency domain, that is, there is no gap between adjacent frequency hopping subbands in frequency domain, so as to ensure that the sensing results of multiple sensing signal blocks of the frequency hopping transmission may be combined to obtain a consecutive large bandwidth. The larger the consecutive bandwidth is, the higher the resolution of target distance sensing is.

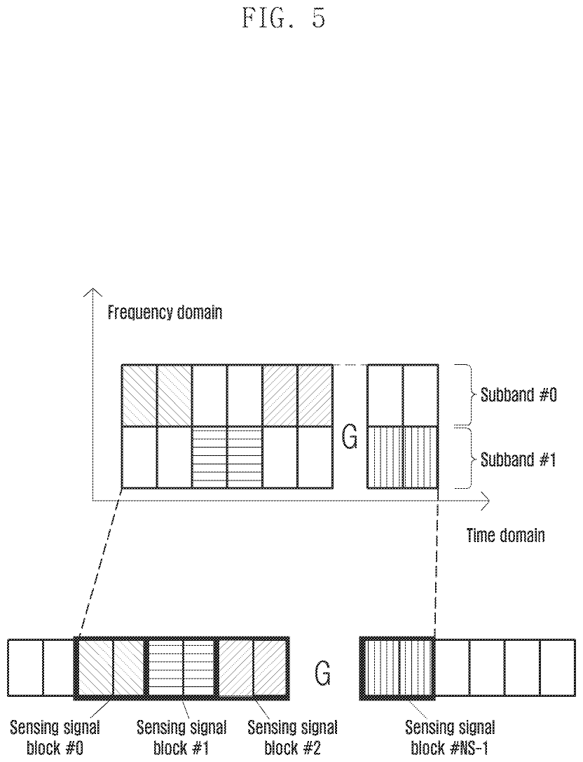

FIG. 5 illustrates a schematic diagram of frequency hopping transmission of a sensing signal according to an embodiment of the disclosure.

Referring to FIG. 5, a number of sensing signal blocks consecutively transmitted in a configured period of time is NS, and a number of time-domain symbols occupied by each sensing signal block is, for example, 2. The sensing signal block is transmitted with frequency hopping between two frequency hopping subbands (e.g., subband #0 and subband #1), and subband #0 and subband #1 do not overlap in frequency domain and are consecutive in frequency domain, which may be combined to constitute a larger bandwidth. For application scenarios with low demand for distance resolution, sensing signal blocks #0 to #NS−1 may be independently used for sensing detection or estimation (for example, detecting the distance of the target object) and combining the detection results. The design based on frequency hopping according to the embodiment can avoid the loss of sensing performance due to deep fading; and for scenarios with high demand for distance resolution, sensing signal blocks #0˜#NS−1 may be combined together for sensing detection, and at this time, a detection result of a target distance is equivalent to the sensing performance of a large bandwidth after frequency hopping subbands are concatenated.

In some aspects, the frequency hopping pattern of the sensing signal may be configured or predefined. The frequency hopping pattern may be used to determine a bandwidth and an initial frequency-domain position of a transmission band of each sensing signal block within the transmission duration. The frequency hopping bandwidth may include several frequency hopping subbands, and a frequency hopping subband of each sensing signal block may be determined according to a one-to-one correspondence between the sensing signal blocks and the frequency hopping subbands, and the determined frequency hopping subband may serve as the transmission band of the sensing signal block. In an example, a number of the frequency hopping subbands (denoted as M) and a start position and a bandwidth of each of the frequency hopping subbands may be predefined values (for example, values predefined by protocols); alternatively, the start position and the bandwidth of each of the frequency hopping subbands may be configured. In another example, the bandwidth of the frequency hopping subbands may be determined according to the frequency hopping bandwidth and the number of the frequency hopping subbands, for example, B_sub=B_hop/M, where B_sub represents the frequency hopping subband bandwidth and B_hop represents the frequency hopping bandwidth. For example, at least one or both of the frequency hopping bandwidth and the number of the frequency hopping subbands M may be configured, for example, through higher layer signaling (e.g., RRC or medium access control (MAC) signaling) and/or physical layer signaling (e.g., downlink control information). Start positions of the frequency hopping subbands may be jointly determined according to indexes of the frequency hopping subbands and the bandwidth of the frequency hopping subbands. For example, a start position of a frequency hopping subband k_(sub_m) with an index of m∈[0,M−1] among M frequency hopping subbands may be k_(sub_m)=k_0+i_m·B_sub, where k_0 is a start position of the frequency hopping bandwidth (or a start position of the 0th frequency hopping subband); {i_m} represents an interleaving mapping sequence of the frequency hopping subband, and there is a one-to-one correspondence between i_m (i_m∈[0,M−1]) and m1 (m∈[0,M−1]). By using the interleaving mapping sequence of the frequency hopping subband, the corresponding sequence between the sensing signal block and the frequency hopping subband for the frequency hopping transmission of the sensing signal block may be disrupted, so that different interleaving mapping sequences of the frequency hopping subband may be generated for adjacent cells. Even if communication nodes of the adjacent cells transmit sensing signal blocks on a same time-domain symbol, transmission bands of the sensing signal blocks are different, which avoids inter-cell interference and randomizes the inter-cell interference. As an example, when the number of the frequency hopping subbands in the frequency hopping bandwidth of the sensing signal is M=1, the sensing signal block is transmitted on the same configured band (i.e. the above frequency hopping bandwidth). The configured band bandwidth may be larger, and at this time, all the sensing signal blocks are transmitted on a larger bandwidth, which may be used in sensing scenarios with high demand for distance resolution.

In some aspects, the frequency hopping transmission of the sensing signal blocks in the sensing signal may be configured to be enabled or disabled. For example, the enabling or disabling of the frequency hopping transmission of the sensing signal blocks in the sensing signal may be configured through higher layer signaling (e.g., RRC or MAC signaling) and/or physical layer signaling (e.g., downlink control information).

According to other embodiments of the disclosure, the sensing signal may be configured with, for example, time-domain resources for performing detection or sensing of an echo signal associated with the sensing signal. In some examples, when the sensing signal is a downlink signal, time-domain resources (e.g., downlink time-domain symbols) that are not available for uplink transmission may be configured (for convenience of description, it may be referred to as a first time interval); and/or when the sensing signal is an uplink signal, time-domain resources (e.g., uplink time-domain symbols) that are not available for downlink transmission may be configured (for convenience of description, it may be referred to as a second time interval). When the sensing signal is a downlink signal, Q consecutive time-domain symbols after the last time-domain symbol of any downlink sensing signal block in the sensing signal may be the configured first time interval or downlink time-domain symbols, where the first time interval is time-domain resources that are not available for uplink transmission; and/or, when the sensing signal is an uplink signal, Q′ consecutive time-domain symbols after the last time-domain symbol of any uplink sensing signal block in the sensing signal may be the configured second time interval or uplink time-domain symbols, where the second time interval is time-domain resources that are not available for downlink transmission. Q is a maximum value of a length of the first time interval (in symbols), and Q′ is a maximum value of a length of the second time interval (in symbols), where Q and Q′ are both positive integers greater than or equal to 0 (for example, Q=0, 1, 2, . . . ). The value of Q (or Q′) may be a fixed value (for example, predefined by protocols), or configured through higher layer signaling (e.g., RRC or MAC signaling) and/or physical layer signaling (e.g., downlink control information). For example, the first time interval may be configured for downlink sensing detection and the second time interval may be configured for uplink sensing detection.

In some aspects, the first time interval and/or the second time interval may be configured to be enabled or disabled. As one example, the enabling or disabling of the first time interval and/or the second time interval may be configured through higher layer signaling (e.g., RRC or MAC signaling) and/or physical layer signaling (e.g., downlink control information). For another example, when the first time interval is configured to be enabled, Q time-domain symbols after the last time-domain symbol of any downlink sensing signal block in the sensing signal are determined as the configured first time interval or downlink time-domain symbols; otherwise, the operation of determining the first time interval is not performed. For yet another example, when the second time interval is configured to be enabled, Q′ time-domain symbols after the last time-domain symbol of any uplink sensing signal block in the sensing signal are determined as the configured second time interval or uplink time-domain symbols; otherwise, the operation of determining the second time interval is not performed.

Whether the first time interval and/or the second time interval are configured to be enabled may be determined based on a maximum value of the length of the configured first time interval Q and/or a maximum value of the length of the configured second time interval Q′. For example, when the maximum value of the length of the first time interval Q is configured as 0, it may be determined that the first time interval is configured to be disabled; otherwise, when the maximum value of the length of the first time interval Q is configured as a positive integer greater than or equal to 1, it may be determined that the first time interval is configured to be enabled. When the maximum value of the length of the first time interval Q is configured as a positive integer greater than or equal to 1, it may be determined that Q time-domain symbols after the last time-domain symbol of any downlink sensing signal block are the configured first time interval or downlink time-domain symbols. For another example, when the maximum value of the length of the second time interval Q′ is configured as 0, it may be determined that the second time interval is configured to be disabled; otherwise, when the maximum value of the length of the second time interval Q′ is configured as a positive integer greater than or equal to 1, it may be determined that the second time interval is configured to be enabled. When the maximum value of the length of the second time interval Q′ is configured as a positive integer greater than or equal to 1, it may be determined that Q′ time-domain symbols after the last time-domain symbol of any downlink sensing signal block are the configured second time interval or uplink time-domain symbols.

Considering that the echo signal will have a large delay after passing through the two-way path between the sensing node and the target object, if the downlink transmission (or uplink transmission) is directly performed after the uplink sensing signal (or downlink sensing signal), the echo signal and the downlink communication signal (or uplink communication signal) will be received by the sensing node at the same time, causing mutual interference. According to the embodiment, the mutual interference between sensing detection and communication signal detection can be avoided by designing the time interval, thereby ensuring the performance of communication and sensing, respectively.

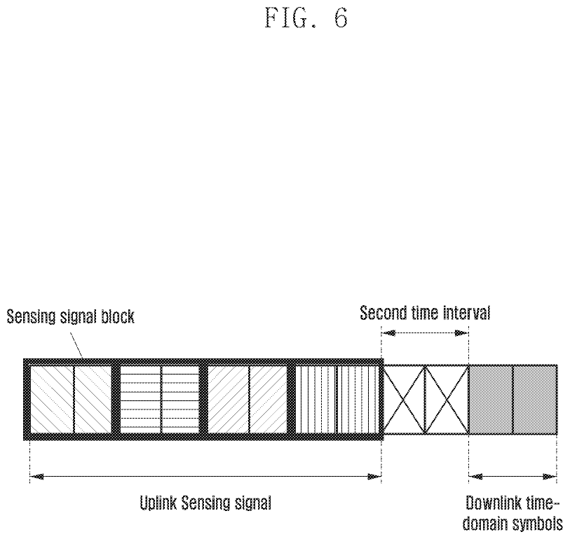

FIG. 6 illustrates a schematic diagram of the second time interval in case that the sensing signal is an uplink signal according to an embodiment of the disclosure.

Referring to FIG. 6, the length of the second time interval Q′ is configured as 2, so two consecutive time-domain symbols after the last time-domain symbol of any uplink sensing signal block are uplink time-domain symbols or the second time interval, that is, they are not available for downlink transmission.

According to other embodiments of the disclosure, a guard interval may be configured for the sensing signal (e.g., each of at least one sensing signal block included in the sensing signal), for example, the guard interval is time-domain resources that are neither available for uplink transmission nor for downlink transmission. In various examples, when the sensing signal is a downlink signal, time-domain resources (which may be referred to as a third time interval for convenience of description) that are neither available for uplink transmission nor for downlink transmission may be configured; and/or when the sensing signal is an uplink signal, time-domain resources (which may be referred to as a fourth time interval for convenience of description) that are neither available for uplink transmission nor for downlink transmission may be configured. In some examples, when the sensing signal is a downlink signal, P consecutive time-domain symbols after the last time-domain symbol of any downlink sensing signal block in the sensing signal are the configured third time interval, where the third time interval is time-domain resources that are neither available for uplink transmission nor for downlink transmission; and/or, in case that the sensing signal is an uplink signal, P′ consecutive time-domain symbols after the last time-domain symbol of any uplink sensing signal block in the sensing signal are the configured fourth time interval, where the fourth time interval is time-domain resources that are neither available for uplink transmission nor for downlink transmission. P is a maximum value of a length of the third time interval configured for the downlink sensing signal, and P′ is a maximum value of a length of the fourth time interval configured for the uplink sensing signal, where P and P′ are both positive integers greater than or equal to 0 (for example, P=0, 1, 2, . . . ). The value of P (or P′) may be a fixed value, or configured through higher layer signaling (e.g., RRC or MAC)/physical layer signaling (e.g., downlink control information).

In some aspects, the third time interval and/or the fourth time interval may be configured to be enabled or disabled. As an example, the enabling or disabling of the third time interval and/or the fourth time interval may be configured through higher layer signaling (e.g., RRC or MAC signaling) and/or physical layer signaling (e.g., downlink control information). For example, when the third time interval is configured to be enabled, it is determined that P time-domain symbols after the last time-domain symbol of any downlink sensing signal block of the sensing signal are neither used for uplink transmission nor for downlink transmission; otherwise, the operation of determining the above guard interval is not performed. For another example, when the fourth time interval is configured to be enabled, it is determined that N time-domain symbols after the last time-domain symbol of any uplink sensing signal block are neither used for uplink transmission nor for downlink transmission; otherwise, the operation of determining the above guard interval is not performed.

Whether the first time interval and/or the second time interval are configured to be enabled may be determined based on a maximum value of the length of the configured third time interval P and/or a maximum value of the length of the configured fourth time interval P′. For example, when P is configured as 0, it may be determined that the third time interval is configured to be disabled; otherwise, when P is configured as a positive integer greater than or equal to 1, it may be determined that the third time interval is configured to be enabled, and, it is determined that each of the P consecutive time-domain symbols after the last time-domain symbol of any downlink sensing signal block in the sensing signal is neither used for uplink transmission nor for downlink transmission. In an example, when P′ is configured as 0, it may be determined that the fourth time interval is configured to be disabled; otherwise, when P′ is configured to be a positive integer greater than or equal to 1, it may be determined that the fourth time interval is configured to be enabled, and, it may be determined that each of the P′ consecutive time-domain symbols after the last time-domain symbol of any uplink sensing signal block in the sensing signal is neither used for uplink transmission nor for downlink transmission.

The third/fourth time interval designed according to an embodiment can avoid the mutual interference between sensing detection and communication signal detection, thereby ensuring the performance of communication and sensing, respectively. Additionally, when a transceiving isolation of the sensing device cannot be ensured, the sensing signal and the communication signal with the same phase (for example, both downlink and uplink) will also cause interference. For example, there will be large local leakage of the downlink communication signal to the receiving end, which will directly affect the echo detection of the sensing signal at the receiving end. In order to ensure the performance of sensing, according to the embodiment of the disclosure, a bidirectional (uplink and downlink) guard interval may be set.

According to an embodiment of the disclosure, a frequency-domain guard band may be configured for the sensing signal. In some examples, there may be a front adjacent frequency-domain guard band and/or a rear adjacent frequency-domain guard band of a band allocated for each sensing signal block, where: there is neither uplink transmission nor downlink transmission in the frequency-domain guard band; or, there is no transmission in the frequency-domain guard band in the same direction as a transmission direction of the sensing signal block, where the transmission direction includes uplink or downlink. A bandwidth of the frequency-domain guard band may be fixed (for example, predefined by protocols), or configured through higher layer signaling (e.g., RRC or MAC) and/or physical layer signaling (e.g., downlink control information). For example, the configured bandwidth of the frequency-domain guard band may be K physical resource blocks (PRBs), where a value of K may be determined through higher layer signaling (e.g., RRC or MAC)/physical layer signaling (e.g., downlink control information). For another example, the front and/or rear adjacent frequency-domain guard bands may be configured to be enabled or disabled. The design of the frequency-domain guard band according to the embodiment of the disclosure can ensure that when receiving the echo signal in the allocated band of the sensing signal block, the reception will not be subjected to the nonlinear interference from adjacent bands in the same transmission direction and/or different transmission direction, thereby ensuring the performance of sensing detection.

According to other embodiments of the disclosure, the sequence of the sensing signal block is mapped to a portion of subcarriers within a band to which each sensing signal block of the sensing signal is allocated. In various examples, a subcarrier to which the sequence of the sensing signal block is mapped is a subcarrier located in the center of the allocated band, that is, the center subcarrier to which the sequence of the sensing signal block is mapped overlaps with the center of the allocated band. At this time, subcarriers in the allocated band of the sensing signal block that are not used for mapping the sequence of the sensing signal block are located on both sides of the mapped subcarrier, and the subcarriers may be used as equivalent frequency-domain guard bands to isolate the adjacent band interference leakage within the bandwidth for sensing detection.

According to various embodiments of the disclosure, the sensing signal may be a periodic sensing signal or configured to be periodic. Each instance of the sensing signal transmitted periodically may be referred to as a sensing signal cluster. For example, the sensing signal cluster is a signal transmission unit that includes at least one sensing signal block and is transmitted on consecutive time units. The sensing signal may be transmitted based on a configuration on periodic transmission. In another example, the configuration on periodic transmission may be fixed (e.g., predefined by protocols) or configurable (e.g., through higher layer signaling (e.g., RRC or MAC) and/or physical layer signaling (e.g., downlink control information) by a base station). In the embodiments of the disclosure, “the sensing signal is a periodic sensing signal or configured to be periodic” can be understood as that resources (e.g., time-domain resources) of the sensing signal are periodic or configured to be periodic.

In some aspects, the configuration on periodic transmission may include at least one or more of the following:
a period indicating a period of the sensing signal;
a (single-beam) duration/(single-beam) sensing signal cluster number, where the (single-beam) duration indicates a duration of sensing signal transmission (using single-beam) and the (single-beam) sensing signal cluster number indicates a number of transmitted sensing signal clusters (using single-beam);
a sensing signal cluster interval indicating a time interval of adjacent sensing signal clusters;
a parameter indicating a number of sensing signal blocks per sensing signal cluster;
a beam number indicating a number of beams for sensing signal transmission; or
a start time offset indicating a time interval between a start time unit of sensing signal transmission in each period and a start time unit of the period, or a time interval between a start time unit of sensing signal transmission in each duration and a start time unit of the duration, or a time interval between a start time unit of sensing signal transmission in each slot/subframe/radio frame and a start time unit of the slot/subframe/radio frame, where the time unit may be, for example, a time-domain symbol.

It should be noted that, in the embodiments of the disclosure, the beam may be referred to as a spatial filter or a spatial domain filter. A spatial domain transmission filter may be referred to as a transmission beam and a spatial domain reception filter may be referred to as a reception beam. In the embodiments, the beam may be a wide beam, a narrow beam or other types of beams.

According to some embodiments, the sensing signal may be an aperiodic sensing signal or configured to be aperiodic. The sensing signal may be transmitted aperiodically based on a configuration on aperiodic transmission. For example, the configuration on aperiodic transmission may be fixed (e.g., predefined by protocols) or configurable (e.g., through higher layer signaling (e.g., RRC or MAC) and/or physical layer signaling (e.g., downlink control information) by a base station). In the embodiments of the disclosure, “the sensing signal is aperiodic or configured to be aperiodic” can be understood as the resources of the sensing signal are aperiodic or configured to be aperiodic.

In some aspects, the configuration on aperiodic transmission may include at least one or more of the following:
information for activating aperiodic transmission of the sensing signal;
a (single-beam) duration/a number of (single-beam) sensing signal clusters, where the (single-beam) duration indicates a duration of sensing signal transmission (using single-beam) and a number of (single-beam) sensing signal clusters indicates a number of transmitted sensing signal clusters (using single-beam);
a sensing signal cluster interval indicating a time interval of adjacent sensing signal clusters;
a parameter indicating a number of sensing signal blocks per sensing signal cluster;
a beam number indicating a number of beams for sensing signal transmission; or
a start time offset indicating a time interval between a start time unit of sensing signal transmission in each period and a start time unit of the period, or a time interval between a start time unit of sensing signal transmission in each duration and a start time unit of the duration, or a time interval between a start time unit of sensing signal transmission in each slot/subframe/radio frame and a start time unit of the slot/subframe/radio frame, where the time unit may be, for example, a time-domain symbol.

In some aspects, the information for activating the aperiodic transmission of the sensing signal may be carried by downlink control information. For example, the downlink control information includes a signaling field indicating the aperiodic transmission or non-transmission of the sensing signal. In this manner, a dynamic and flexible aperiodic transmission mechanism of the sensing signal may be supported.

According to other embodiments of the disclosure, the sensing signal may be transmitted using a single beam. The transmission using a single beam will be illustrated with an example of transmission of a periodic sensing signal. It should be noted that the transmission method of the periodic sensing signal described below may be similarly applied to transmission of the aperiodic sensing signal. The difference between the transmission method of the periodic sensing signal and the transmission method of the aperiodic sensing signal may be that the periodic sensing signal needs acquiring of periodic parameters, while the aperiodic sensing signal does not need acquiring of periodic parameters; moreover, the aperiodic sensing signal needs acquiring of information for activating the aperiodic transmission of the sensing signal, while the periodic sensing signal method does not need acquiring of information for activating the aperiodic transmission of the sensing signal. The parameters in the following description may be fixed (e.g., predefined by protocols) or configurable (e.g., through higher layer signaling (e.g., RRC or MAC) and/or physical layer signaling (e.g., downlink control information) by a base station).

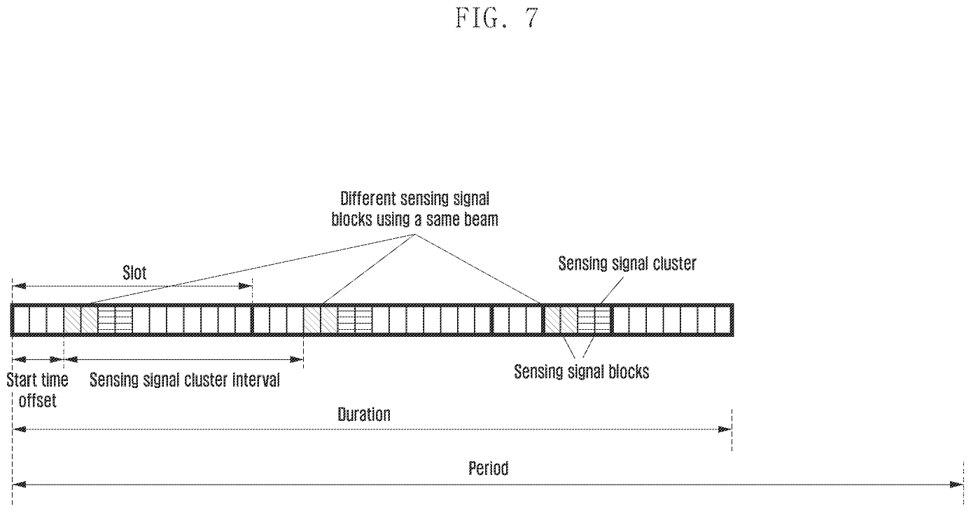

FIG. 7 illustrates a schematic diagram of periodic sensing signal transmission according to an embodiment of the disclosure.

In a configured period T, a sensing signal cluster is configured to be transmitted for Nclust times, in which any adjacent sensing signal clusters are spaced by F (in the example of FIG. 7, F is 14) time units (e.g., symbols), and each sensing signal cluster includes G (in the example of FIG. 7, G is 2) sensing signal blocks, where T, Nclust, F and G are configurable parameters. A configuration of a start time offset may be acquired, which is used to determine a start time unit position at which the first sensing signal cluster is transmitted in a period/(single-beam) duration. Alternatively, a configuration of a sensing signal cluster number Nclust may be replaced by a configuration of a duration which indicates a total time for transmitting N sensing signal clusters in a period. Additionally, the related parameters of the sensing signal block, such as the repetition times of the sequence in the sensing signal block, the subcarrier spacing of the sensing signal block, the frequency-domain mapping, the frequency hopping bandwidth, the frequency hopping subband bandwidth, etc., as described above, may be fixed (e.g., predefined by protocols) or configurable (e.g., through higher layer signaling (e.g., RRC or MAC) and/or physical layer signaling (e.g., downlink control information) by a base station), which will not be re-described here. In the embodiments, when the communication-sensing node is a terminal, acquiring or identifying or determining a configuration may include receiving the configuration from a base station, and/or the terminal autonomously acquiring or identifying or determining the configuration. When the communication-sensing node is a base station, acquiring or identifying or determining a configuration may include the base station autonomously acquiring or identifying or determining the configuration.

The configuration and transmission method of the sensing signal according to the embodiment of the disclosure can meet the characteristic of the sensing signal required for detecting a moving speed (doppler frequency) of the target object. In an example, the speed detection of the target object needs to transmit the sensing signal at equal intervals with the configured time interval within the configured duration for several times, where the configuration of the duration is related to the resolution requirement for the speed detection of the target object, and the configuration of the time interval is related to the distance requirement for the speed detection of the target object. Additionally, according to the design of the sensing signal cluster in the embodiments of the disclosure, multiple sensing signal blocks may be transmitted within an occasion in which the sensing signal is transmitted once, and different sensing signal blocks may be combined when they are received to improve the signal-to-noise ratio of sensing detection, or reconstructed and interpolated when they are received for the speed detection of the target object, so as to reduce the requirement for the duration of sensing signal in the speed detection of the target object. For the transmission of the periodic sensing signal, an appropriate sensing signal transmission period may be set according to an upper limit of the moving speed of the target object, and the system overhead may be reduced as much as possible under the condition of satisfying the sensing detection. In addition, the introducing of the configuration of the start time offset can make the sensing signals of different cells be transmitted on different time units even if the other configurations are the same. For example, different cells are configured with different start time offsets, thereby ensuring that there is no interference with each other in the sensing detection in different cells.

According to various embodiments of the disclosure, the sensing signal may be transmitted using multiple beams. The transmission using multiple beams will be illustrated with an example of transmission of a periodic sensing signal. It should be noted that the transmission method of the periodic sensing signal described below may be similarly applied to transmission of an aperiodic sensing signal. The difference between the transmission method of the periodic sensing signal and the transmission method of the aperiodic sensing signal may be that the periodic sensing signal needs acquiring of periodic parameters, while the aperiodic sensing signal does not need acquiring of periodic parameters; moreover, the aperiodic sensing signal needs acquiring of information for activating the aperiodic transmission of the sensing signal, while the periodic sensing signal method does not need acquiring of information for activating the aperiodic transmission of the sensing signal. The parameters in the following description may be fixed (e.g., predefined by protocols) or configurable (e.g., through higher layer signaling (e.g., RRC or MAC) and/or physical layer signaling (e.g., downlink control information) by a base station).

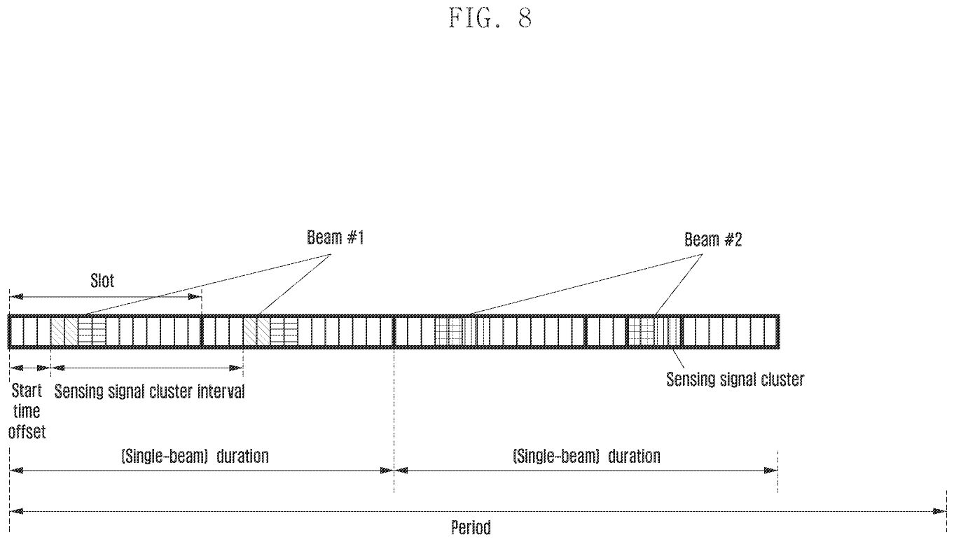

FIG. 8 illustrates a schematic diagram of periodic sensing signal transmission according to an embodiment of the disclosure.

In a configured period T, the sensing signal is transmitted with Krepeat transmission beams (that is, a single-beam duration will be repeated for Krepeat times, each time corresponding to a different transmission beam), where in each single-beam duration, the sensing signal cluster is configured to be transmitted for Nclust times, in which any adjacent sensing signal clusters are spaced by F (in the example of FIG. 8, F is 14) time units (e.g., symbols), and each sensing signal cluster includes G (in the example of FIG. 8, G is 2) sensing signal blocks, where T, Krepeat, Nclust, F and G are all configurable parameters. A configuration of the start time offset may, for example, also be acquired, which is used to determine a start time unit position at which the first sensing signal cluster is transmitted in a period/(single-beam) duration. Alternatively, a configuration of the number Nclust of sensing signal clusters may be replaced by a configuration of the duration which indicates a total time for transmitting N sensing signal clusters in a period. In addition, the related parameters of the sensing signal block, such as the repetition times of the sequence in the sensing signal block, the subcarrier spacing of the sensing signal block, the frequency-domain mapping, frequency hopping bandwidth, the frequency hopping subband bandwidth, etc., as described above, may be fixed (e.g., predefined by protocols) or configurable (e.g., through higher layer signaling (e.g., RRC or MAC) and/or physical layer signaling (e.g., downlink control information) by a base station), which will not be re-described here.

The configuration and transmission method of the sensing signal according to the embodiments of the disclosure cannot only have the benefits described above for single-beam sensing signal transmission, but also can support the function of multi-beam sensing signal transmission. Because the single-beam coverage is narrow, when the target object has a lateral moving speed (angular velocity), it is impossible to detect the lateral moving target object only by using the sensing signal of a single beam. It is necessary to realize the detection of the lateral moving speed of the target object by multiple transmission beam sweeping. In addition, if the high resolution of radial velocity is required for sensing, a long single-beam duration is needed. In order to avoid the influence of a long duration of the same beam on downlink communication, multiple transmission beams close in direction (e.g., adjacent beams) may be used with the above design. If the duration of each beam is short, the sensing results of multiple narrow beams close in direction may be processed together, which is equivalent to the sensing results of a single wide beam with a long duration, so as to obtain high-resolution radial velocity detection without affecting the coverage of downlink communication.

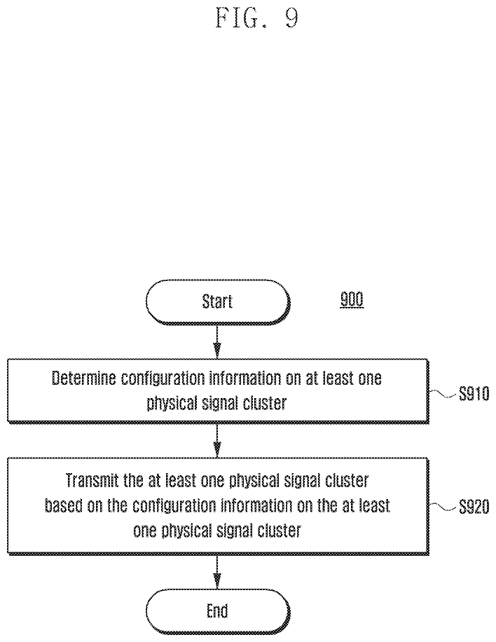

FIG. 9 illustrates a method performed by a communication apparatus in a wireless communication system according to an embodiment of the disclosure.

For example, the communication apparatus may operate as a communication-sensing node. For example, the communication apparatus may include a terminal or a network node (e.g., a base station).

Referring to FIG. 9, in operation S910, the communication apparatus determines configuration information on at least one physical signal cluster. The physical signal cluster may include at least one physical signal block, and a physical signal block of the at least one physical signal block includes N repetitions of a sequence, where N is an integer greater than or equal to 1.

Next, in operation S920, the communication apparatus transmits the at least one physical signal cluster based on the configuration information on the at least one physical signal cluster.

In some aspects, one or more of operations S910 or S920 may be performed based on the various embodiments described above.

In some aspects, the method 900 may include the methods or operations that may be performed by the communication-sensing node in the various embodiments described above.

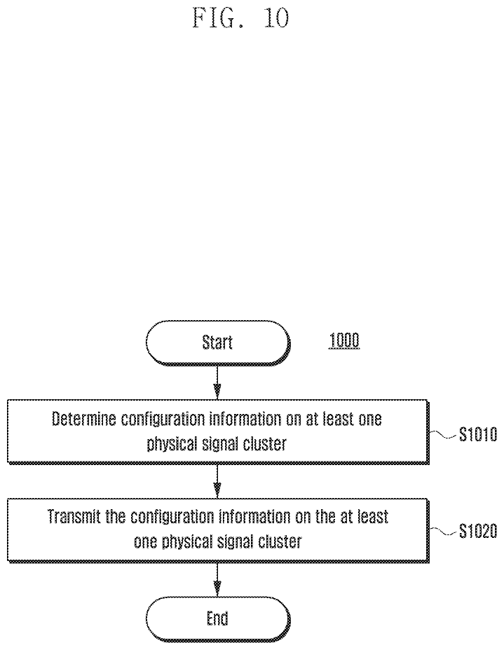

FIG. 10 illustrates a method performed by a communication apparatus in a wireless communication system according to an embodiment of the disclosure.

For example, the communication apparatus may communicate with and configure a communication-sensing node. For another example, the communication apparatus may include a terminal or a network node (e.g., a base station). For yet another example, when the communication apparatus in FIG. 9 is a terminal, the communication apparatus in FIG. 10 may be a base station or another terminal; and when the communication apparatus in FIG. 9 is a base station, the communication apparatus in FIG. 10 may be another base station.

Referring to FIG. 10, in operation S1010, the communication apparatus determines configuration information on at least one physical signal cluster. The physical signal cluster may include at least one physical signal block, and a physical signal block of the at least one physical signal block includes N repetitions of a sequence, where N is an integer greater than or equal to 1.

Next, in operation S1020, the communication apparatus transmits the configuration information on the at least one physical signal cluster.

In some aspects, one or more of operations S1010 or S1020 may be performed based on the various embodiments described above.

In some aspects, the method 1000 may include the methods or operations that may be performed by the communication apparatus configuring the communication-sensing node in the various embodiments described above.

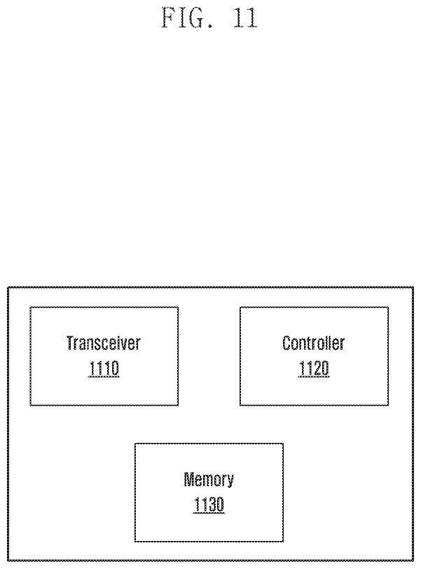

FIG. 11 is a block diagram of a terminal according to an embodiment of the disclosure.

Referring to FIG. 11, the terminal includes a transceiver 1110, a controller 1120 and a memory 1130. The controller 1120 may refer to a circuit, an application specific integrated circuit (ASIC) or at least one processor. The transceiver 1110, the controller 1120 and the memory 1130 are configured to perform the operations that may be performed by the terminal in the various embodiments described above. Although the transceiver 1110, the controller 1120 and the memory 1130 are shown as separate entities, they may be implemented as a single entity, such as a single chip. Alternatively, the transceiver 1110, the controller 1120 and the memory 1130 may be electrically connected or coupled to each other.

The transceiver 1110 may transmit and receive signals to and from other network entities (e.g., base stations).

The controller 1120 may control the terminal to perform the functions according to one of the above embodiments. According to various embodiments of the disclosure, the controller 1120 controls the transceiver 1110 and/or the memory 1130 to perform communication-sensing related operations. According to other embodiments of the disclosure, the terminal may operate as a communication-sensing node (e.g., transmit sensing signals) and/or communicate with the communication-sensing node (e.g., transmit various configuration information to the communication-sensing node).

In one embodiment, the operations of the terminal may be implemented by using the memory 1130 storing corresponding program codes. Specifically, the terminal may be equipped with the memory 1130 to store program codes for implementing desired operations. In order to perform the desired operations, the controller 1120 may read and execute the program codes stored in the memory 1130 by using at least one processor or central processing unit (CPU).

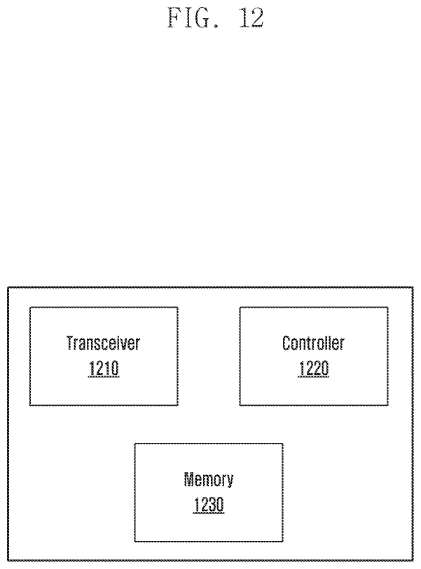

FIG. 12 is a block diagram of a base station according to an embodiment of the disclosure.

Referring to FIG. 12, a base station includes a transceiver 1210, a controller 1220 and a memory 1230. The controller 1220 may refer to a circuit, an application specific integrated circuit (ASIC) or at least one processor. The transceiver 1210, the controller 1220 and the memory 1230 are configured to perform the operations that may be performed by the base station in the various embodiments described above. Although the transceiver 1210, the controller 1220 and the memory 1230 are shown as separate entities, they may be implemented as a single entity, such as a single chip. Alternatively, the transceiver 1210, the controller 1220 and the memory 1230 may be electrically connected or coupled to each other.

The transceiver 1210 may transmit and receive signals to and from other network entities (e.g., terminals).

The controller 1220 may control the base station to perform the functions according to one of the above embodiments. According to various embodiments of the disclosure, the controller 1220 controls the transceiver 1210 and/or the memory 1230 to perform communication-sensing related operations. According to other embodiments of the disclosure, the base station may operate as a communication-sensing node (e.g., transmit sensing signals) and/or communicate with (e.g., configure) the communication-sensing node (e.g., a terminal).

In an embodiment, the operations of the base station may be implemented by using the memory 1230 storing corresponding program codes. Specifically, the base station may be equipped with the memory 1230 to store program codes for implementing desired operations. In order to perform the desired operations, the controller 1220 may read and execute the program codes stored in the memory 1230 by using at least one processor or central processing unit (CPU).

Those skilled in the art will understand that the above illustrative embodiments are described herein and are not intended to be limiting. It should be understood that any two or more of the embodiments disclosed herein may be combined in any combination. Other embodiments may be utilized and other changes may be made without departing from the spirit and scope of the subject matter presented herein. It will be readily understood that aspects of the disclosure as generally described herein and shown in the drawings may be arranged, replaced, combined, separated and designed in various different configurations, all of which are contemplated herein.

Those skilled in the art will understand that the various illustrative logical blocks, modules, circuits, and steps described in this application may be implemented as hardware, software, or a combination of both. To clearly illustrate this interchangeability between hardware and software, various illustrative components, blocks, modules, circuits, and steps are generally described above in the form of their functional sets. Whether such function sets are implemented as hardware or software depends, for example, on the specific application and the design constraints imposed on the overall system. Technicians may implement the described functional sets in different ways for each specific application, but such design decisions should not be interpreted as causing a departure from the scope of this application.

The various illustrative logic blocks, modules, and circuits described in this application may be implemented or performed by a general purpose processor, a Digital Signal Processor (DSP), an Application Specific Integrated Circuit (ASIC), a Field Programmable Gate Array (FPGA) or other programmable logic devices, discrete gates or transistor logics, discrete hardware components, or any combination thereof designed to perform the functions described herein. The general-purpose processor may be a microprocessor, but in an alternative, the processor may be any conventional processor, controller, microcontroller, or state machine. The processor may also be implemented as a combination of computing devices, such as a combination of a DSP and a microprocessor, a plurality of microprocessors, one or more microprocessors cooperating with a DSP core, or any other such configuration.

The steps of the method or algorithm described in this application may be embodied directly in hardware, in a software module executed by a processor, or in a combination thereof. The software module may reside in RAM memory, flash memory, ROM memory, EPROM memory, EEPROM memory, register, hard disk, removable disk, or any other form of storage medium known in the art. A storage medium is coupled to a processor to enable the processor to read and write information from/to the storage media. In an alternative, the storage medium may be integrated into the processor. The processor and the storage medium may reside in an ASIC. The ASIC may reside in a user terminal. In an alternative, the processor and the storage medium may reside in the user terminal as discrete components.

In one or more designs, the functions may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another. The storage medium may be any available medium that can be accessed by a general purpose or special purpose computer.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a communication apparatus in a wireless communication system, the method comprising:
determining configuration information on at least one physical signal cluster; and
transmitting the at least one physical signal cluster based on the configuration information on the at least one physical signal cluster,
wherein the physical signal cluster includes at least one physical signal block,
wherein the physical signal block includes N repetitions of a sequence, and
wherein the N is an integer greater than or equal to 1.

2. The method of claim 1, wherein the configuration information on the at least one physical signal cluster includes at least one of:
information indicating that the at least one physical signal cluster is aperiodic or periodic,
information on a duration of the at least one physical signal cluster, information on a number of the at least one physical signal cluster,
information on a time interval between adjacent physical signal clusters of the at least one physical signal cluster,
information on a number of the physical signal blocks in the physical signal cluster,
information on a number of the repetitions of the sequence included in the physical signal block,
information on a beam used for the at least one physical signal cluster, a start time offset of transmission of the at least one physical signal cluster,
a subcarrier spacing of the physical signal block in the physical signal cluster,
a frequency-domain mapping of the at least one physical signal cluster,
a frequency hopping pattern of the at least one physical signal cluster,
a frequency hopping bandwidth of the at least one physical signal cluster,
a number of frequency hopping subbands within the frequency hopping bandwidth of the at least one physical signal cluster, or
a bandwidth of each frequency hopping subband within the frequency hopping bandwidth of the at least one physical signal cluster.

3. The method of claim 2, wherein the subcarrier spacing of the physical signal block is configured such that a length of a time-domain symbol occupied by the physical signal block is greater than that of other time-domain symbols of a time unit including the time-domain symbol.

4. The method of claim 2,
wherein bands of the physical signal blocks are allocated based on the frequency hopping pattern,
wherein the frequency hopping pattern is configured such that bands of at least two of the at least one physical signal block included in the physical signal cluster do not completely overlap, and
wherein the frequency hopping pattern is configured such that there is no gap between adjacent bands of the bands allocated to the at least one physical signal block included in the physical signal cluster.

5. The method of claim 2, wherein the frequency-domain mapping is configured such that the sequence of each physical signal block of the physical signal cluster is mapped to a subcarrier at a center of a band allocated for the physical signal block.

6. The method of claim 1,
wherein the physical signal cluster is a downlink signal, and the configuration information further includes a first configuration that Q consecutive time-domain symbols after a last time-domain symbol of any physical signal block or a last physical signal block in the physical signal cluster are not available for uplink physical channels or uplink physical signals, where Q is an integer greater than or equal to 1, or
wherein the physical signal cluster is an uplink signal, and the configuration information further includes a second configuration that Q′ consecutive time-domain symbols after the last time-domain symbol of any physical signal block or the last physical signal block in the physical signal cluster are not available for downlink physical channels or downlink physical signals, where Q′ is an integer greater than or equal to 1, and
wherein in case that the first configuration is enabled, it is determined that the Q consecutive time-domain symbols after the last time-domain symbol of any physical signal block or the last physical signal block in the physical signal cluster are not available for uplink physical channels or uplink physical signals, or
wherein the second configuration is enabled, it is determined that the Q′ consecutive time-domain symbols after the last time-domain symbol of any physical signal block or the last physical signal block in the physical signal cluster are not available for downlink physical channels or downlink physical signals.

7. The method of claim 1,
wherein the physical signal cluster is a downlink signal, and the configuration information further includes a third configuration that P consecutive time-domain symbols after the last time-domain symbol of any physical signal block or the last physical signal block in the physical signal cluster are neither available for uplink physical channels or uplink physical signals nor for downlink physical channels or downlink physical signals, where P is an integer greater than or equal to 1, or
wherein the physical signal cluster is an uplink signal, and the configuration information further includes a fourth configuration that P′ consecutive time-domain symbols after the last time-domain symbol of any physical signal block or the last physical signal block in the physical signal cluster are neither available for uplink physical channels or uplink physical signals nor for downlink physical channels or downlink physical signals, where P′ is an integer greater than or equal to 1, and
wherein in case that the third configuration is enabled, the P consecutive time-domain symbols after the last time-domain symbol of any physical signal block or the last physical signal block in the physical signal cluster are neither available for uplink physical channel or uplink physical signal nor for downlink physical channel or downlink physical signal, or
wherein in case that the fourth configuration is enabled, the P′ consecutive time-domain symbols after the last time-domain symbol of any physical signal block or the last physical signal block in the physical signal cluster are neither available for uplink physical channels or uplink physical signals nor for downlink physical channels or downlink physical signals.

8. The method of claim 1,
wherein one or more frequency-domain resources adjacent to a band allocated to each physical signal block of the physical signal cluster are neither available for uplink physical channels or uplink physical signals nor for downlink physical channels and/or downlink physical signals, and
wherein the determining of the configuration information on the at least one physical signal cluster includes receiving the configuration information on the at least one physical signal cluster via a radio resource control (RRC) message, a downlink control information (DCI) message or a combination thereof.

9. The method of claim 1, further comprising:
transmitting the configuration information on the at least one physical signal cluster via a radio resource control (RRC) message, a downlink control information (DCI) message or a combination thereof.

10. The method of claim 1,
wherein the physical signal block is generated by mapping the sequence to a plurality of subcarriers on a time-domain symbol,
wherein a difference of indexes of adjacent subcarriers of the plurality of subcarriers on the time-domain symbol to which the sequence is mapped is 2*k, where k is a non-zero integer,
wherein the at least one physical signal block is consecutive in time,
wherein the physical signal block includes the N repetitions of the sequence in at least one consecutive time-domain symbol, and
wherein a number of the at least one consecutive time-domain symbol is N.

11. A communication apparatus in a wireless communication system, the communication apparatus comprising:
a transceiver; and
one or more processors communicatively coupled with the transceiver; and
memory storing one or more computer programs including computer-executable instructions that, when executed by the one or more processors, cause the communication apparatus to:
determine configuration information on at least one physical signal cluster, and
transmit the at least one physical signal cluster based on the configuration information on the at least one physical signal cluster,
wherein the physical signal cluster includes at least one physical signal block,
wherein the physical signal block includes N repetitions of a sequence, and
wherein the N is an integer greater than or equal to 1.

12. The communication apparatus of claim 11, wherein the configuration information on the at least one physical signal cluster includes at least one of:
information indicating that the at least one physical signal cluster is aperiodic or periodic,
information on a duration of the at least one physical signal cluster,
information on a number of the at least one physical signal cluster,
information on a time interval between adjacent physical signal clusters of the at least one physical signal cluster,
information on a number of the physical signal blocks in the physical signal cluster,
information on a number of the repetitions of the sequence included in the physical signal block,
information on a beam used for the at least one physical signal cluster, a start time offset of transmission of the at least one physical signal cluster,
a subcarrier spacing of the physical signal block in the physical signal cluster, a frequency-domain mapping of the at least one physical signal cluster,
a frequency hopping pattern of the at least one physical signal cluster,
a frequency hopping bandwidth of the at least one physical signal cluster,
a number of frequency hopping subbands within the frequency hopping bandwidth of the at least one physical signal cluster, or
a bandwidth of each frequency hopping subband within the frequency hopping bandwidth of the at least one physical signal cluster.

13. The communication apparatus of claim 12, wherein the subcarrier spacing of the physical signal block is configured such that a length of a time-domain symbol occupied by the physical signal block is greater than that of other time-domain symbols of a time unit including the time-domain symbol.

14. The communication apparatus of claim 12,
wherein bands of the physical signal blocks are allocated based on the frequency hopping pattern,
wherein the frequency hopping pattern is configured such that bands of at least two of the at least one physical signal block included in the physical signal cluster do not completely overlap, and
wherein the frequency hopping pattern is configured such that there is no gap between adjacent bands of the bands allocated to the at least one physical signal block included in the physical signal cluster.

15. The communication apparatus of claim 12, wherein the frequency-domain mapping is configured such that the sequence of each physical signal block of the physical signal cluster is mapped to a subcarrier at a center of a band allocated for the physical signal block.

16. The communication apparatus of claim 11,
wherein the physical signal cluster is a downlink signal, and the configuration information further includes a first configuration that Q consecutive time-domain symbols after a last time-domain symbol of any physical signal block or a last physical signal block in the physical signal cluster are not available for uplink physical channels or uplink physical signals, where Q is an integer greater than or equal to 1, or
wherein the physical signal cluster is an uplink signal, and the configuration information further includes a second configuration that Q′ consecutive time-domain symbols after the last time-domain symbol of any physical signal block or the last physical signal block in the physical signal cluster are not available for downlink physical channels or downlink physical signals, where Q′ is an integer greater than or equal to 1, and
wherein, in case that the first configuration is enabled, it is determined that the Q consecutive time-domain symbols after the last time-domain symbol of any physical signal block or the last physical signal block in the physical signal cluster are not available for uplink physical channels or uplink physical signals, or
wherein the second configuration is enabled, it is determined that the Q′ consecutive time-domain symbols after the last time-domain symbol of any physical signal block or the last physical signal block in the physical signal cluster are not available for downlink physical channels or downlink physical signals.

17. The communication apparatus of claim 11,
wherein the physical signal cluster is a downlink signal, and the configuration information further includes a third configuration that P consecutive time-domain symbols after the last time-domain symbol of any physical signal block or the last physical signal block in the physical signal cluster are neither available for uplink physical channels or uplink physical signals nor for downlink physical channels or downlink physical signals, where P is an integer greater than or equal to 1, or
wherein the physical signal cluster is an uplink signal, and the configuration information further includes a fourth configuration that P′ consecutive time-domain symbols after the last time-domain symbol of any physical signal block or the last physical signal block in the physical signal cluster are neither available for uplink physical channels or uplink physical signals nor for downlink physical channels or downlink physical signals, where P′ is an integer greater than or equal to 1, and
wherein in case that the third configuration is enabled, the P consecutive time-domain symbols after the last time-domain symbol of any physical signal block or the last physical signal block in the physical signal cluster are neither available for uplink physical channel or uplink physical signal nor for downlink physical channel or downlink physical signal, or
wherein in case that the fourth configuration is enabled, the P′ consecutive time-domain symbols after the last time-domain symbol of any physical signal block or the last physical signal block in the physical signal cluster are neither available for uplink physical channels or uplink physical signals nor for downlink physical channels or downlink physical signals.

18. The communication apparatus of claim 11,
wherein one or more frequency-domain resources adjacent to a band allocated to each physical signal block of the physical signal cluster are neither available for uplink physical channels or uplink physical signals nor for downlink physical channels and/or downlink physical signals, and
wherein the determining of the configuration information on the at least one physical signal cluster includes receiving the configuration information on the at least one physical signal cluster via a radio resource control (RRC) message, a downlink control information (DCI) message or a combination thereof.

19. The communication apparatus of claim 11, wherein the one or more computer programs further comprise computer-executable instructions to:
transmit the configuration information on the at least one physical signal cluster via a radio resource control (RRC) message, a downlink control information (DCI) message or a combination thereof.

20. The communication apparatus of claim 11,
wherein the physical signal block is generated by mapping the sequence to a plurality of subcarriers on a time-domain symbol,
wherein a difference of indexes of adjacent subcarriers of the plurality of subcarriers on the time-domain symbol to which the sequence is mapped is 2*k, where k is a non-zero integer,
wherein the at least one physical signal block is consecutive in time,
wherein the physical signal block includes the N repetitions of the sequence in at least one consecutive time-domain symbol, and
wherein a number of the at least one consecutive time-domain symbol is N.
